(19) United States
(12) Patent Application Publication
(10) Pub. No.: US 2007/0271234 A1
(43) Pub. Date: Nov. 22, 2007

(54) Information Exchange Among Members of a Group of Communication Device Users

(76) Inventor: Chickmangalore N. Ravikiran, Altamonte Springs, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/535,681

(22) Filed: Sep. 27, 2006

Related U.S. Application Data
(60) Provisional application No. 60/747,876, filed on May 22, 2006.

(51) Int. Cl. G06F 17/30

(52) U.S. Cl. 707/3

(57) ABSTRACT

A method, system, and apparatus for controlling transmission and reception of communications between a plurality of telecommunication devices in a group to allow searching of stored resources is provided. The invention includes a group management module for creating and maintaining association links for each of the plurality of telecommunication devices representing a logical network of devices. The invention also includes a search engine for transmission and reception of communications between the devices in a group, the search engine configured to route a search query from an originating device along the association links to all devices in the group, search stored resources in all devices in the group, and return results of the search query to the originating device, thereby allowing searching of stored resources on all the plurality of telecommunication devices without relying on a centralized server or physical network or wireless network for storing resources.

### CROSS REFERENCE TO RELATED APPLICATIONS

This application claims benefit to U.S. Provisional Application Ser. No. 60/747,876 filed May 22, 2006, incorporated herein in its entirety by reference.

### TECHNICAL FIELD

This invention relates generally to information exchange among members of a group of communication device users. More particularly, it relates to a method, system, and apparatus for controlling transmission and reception of communications between a plurality of devices in a group to allow searching of stored resources on the devices, including group management and a search engine, thereby allowing searching without relying on a centralized server or physical network or wireless network for storing resources.

### BACKGROUND ART

The current technology for sharing information among a plurality of mobile phone users involves using a server (as an intermediary) and/or point-to-point. As shown in FIG. 1, prior art, mobile phone users share information among themselves using a server (as an intermediary) and/or point-to-point communication. In the first method, a user transfers and stores digital content to an intermediary. Other users establish connection with the intermediary, discover content, and download the required content. In the second method, a user directly transfers specific information to one or more phones. Transferring information to a server/intermediary or using point-to-point connection is associated with several problems, including but not limited to: (1) Data on the mobile phone and on the intermediary, quite often, can become out date or out of sync; as a consequence, the user has to deal with synchronization issues (2) The current techniques are non-intuitive and extremely inconvenient to promote habitual usage. New users, particularly technologically non-savvy users, will have to overcome steep learning curve regarding usage techniques. Users have to upload the content whenever there is new information or whenever information changes. If a user forgets or doesn't transfer the information to the server, then it is not available for discovery. (3) One user might store on one server and other user might store on a different server. Consequently, users should remember the server information used by the individual users, so that they can accurately connect to those servers for discovering information. (4) A user should be connected to a network to transfer the information to the server; however, they may use some messaging techniques to transfer the information to a server when they encounter connectivity issues. But still they are relying on a server and users should connect to this server to discover it. (5) Users, quite often, are restricted with the amount of storage space allocated to them on the server. Besides, there are several administrative and maintenance issues associated with the server, which consumes a significant amount of time, money and other valuable resources. Furthermore, the user has to attend to maintenance issues associated with his/her mobile phone. (6) During times when the server is unavailable, due to maintenance and other reasons, the user cannot transfer any content to the server and other users would not be able to discover information during this time. (7) Current techniques are limited to point to point search only. If user-A transfers information to an intermediary, user-B can search and retrieve user-A's information only. If user-B wants to search user-C's information at the same time, then user-B should explicitly specify in the search request to search user-C's information. User-B has to assume that user-C has already transferred the information to the same server. In the current technique, user-B cannot concurrently discover information transferred from multiple mobile phones without specifying user-B's mobile phone's information in the search request. If user-B doesn't have user-C's information then user-B might not be able to search the required information. In other words, user-B cannot search information transferred by a group of mobile phones without explicitly specifying individual mobile phone information in the search request. (8) Not all the users can participate in discovering and sharing process—the current techniques limits participation. Individual user accounts should be created for every user. For instance, if the user id or user account is not created on a server, or if a particular user runs out of space on the server then that particular user is blocked out from participation. Consequently, the IT infrastructure personnel will be inundated with user account maintenance issues, and resolving these issues can take a significant amount of time and money. (9) Data stored on the server is not guaranteed to be private. Any data stored in a centralized place raises privacy issues and concerns. If the user decides to stop using the server and switches to some other server, there is no guarantee that the data stored on the server will be permanently erased. Backups will be taken and may be subjected to auditing/legal procedures. (10) Users are hesitant to store personal data on a server; Mobile phone is a very personal device, and users are too cautious about what they are willing to share with others. They want to be in full control on the information they are sharing with others—information about what they are sharing, information about how they are sharing, information about when they are sharing. None of the current techniques provide a comprehensive solution to share information in a controlled fashion. (11) The current techniques are time consuming to use—maintaining data locally and on the server, uploading content, keeping track of users and so on. (12) Mobile phone is a very impulsive device that can be used at the slightest impulse. Existing search techniques are non-impulsive to encourage habitual usage. (13) In point-to-point communication, the sender is limited to pushing information for his/her mobile phone to one or more receivers. A receiver cannot dynamically discover information on sender's mobile phone and retrieve the required content. (14) In point-to-point sharing, if the sender and receiver are using Infra Red or Bluetooth or similar technology for transferring data, these technologies have very limited coverage area (less than 100 feet, and sometimes less than 10 feet).

Moreover, in the current techniques, in order to search, both the searcher and provider should be connected to a network—wireless or wired. A number of problems are associated with connecting to a network, including but not limited to: (1) If a user wants to do a search, the user and the server (or device that provides the search result i.e. provider) should be both connected to a network. If the server or the provider is not connected to the network at the time the user initiates a query, then the user will not be able to discover information. (2) If user-A is connected to network-1 and user-B is connected to network-2 then user-C from network-3 is not able to search user-A or user-B, unless all networks are connected to the Internet/Intranet (WAN, LAN, etc.), and all users configure their devices to be universally accessed by everyone, and all firewalls/routers are configured for cross network access. In reality, not all devices in a network are accessible from the Internet. There are plenty of mobile phones that are never connected to a network and always work in stand alone mode. Our invention focuses on mobile phones that are not connected to the network. (3) Due to certain inherent technical limitations, a mobile phone cannot be a part of multiple networks at the same time and maintain active connections in multiple networks. In some instances, even if they belong to multiple networks, they might not be always actively connected to them. (4) Limited Participation: It is practically impossible to expect all the mobile phones to be connected to the Internet or one single network at the same time. Besides, both the sender and receiver, or the discoverer and the provider, should be concurrently connected to the network. Furthermore, the discoverer, before initiating a search, should have prior knowledge about all the nodes or all the mobile phones that are connected to the network. Otherwise, the discoverer might not be able to search all the nodes.

Accordingly, there is a need in the art to address these problems.

A number of other patents exist which relate to mobile phones and/or data sharing and information exchange including, U.S. Patent and Application Nos. US20060053389A1, US20060026216A1, US20050190273A1, US20050188010A1, US20050172001A1, US6934702, US20050064852A1, WO04075169A2, US20040137921A1, US20040044727A1, US20040044774A1, US20040039781A1, US20040023644A1, U.S. Pat. No. 6,470,190, and U.S. Pat. No. 7,069,308; all of which are incorporated herein by reference.

### SUMMARY OF THE INVENTION

In various embodiments, the present invention provides improvements over the systems described above. Broadly speaking, the present invention comprises a method, system, and apparatus for controlling transmission and reception of communications between a plurality of devices in a group to allow searching of stored resources on the devices, including group management and a search engine, thereby allowing searching without relying on a centralized server or physical network or wireless network for storing resources. The invention can be implemented in numerous ways, including as a system, a device/apparatus, and a method. Parts of the invention may exist on a computer readable medium.

As a system, an embodiment of the invention comprises a communication system for controlling transmission and reception of communications between a plurality of telecommunication devices in a group to allow searching of resources stored on the plurality of telecommunication devices, comprising (a) group management module for creating and maintaining association links for each of the plurality of telecommunication devices, wherein the association links of all the telecommunication devices in the group represent a logical network of telecommunication devices; and (b) search engine for transmission and reception of communications between a plurality of telecommunication devices in a group, the search engine configured to route a search query from an originating telecommunication device along said association links to all telecommunication devices in the group, search stored resources in all telecommunication devices in the group, and return results of the search query to the originating telecommunication device, thereby allowing searching of stored resources on all the plurality of telecommunication devices without relying on a centralized server or physical network or wireless network for storing resources.

In specific embodiments of the invention, the telecommunication devices are mobile devices, such as cellular telephones, digital mobile phones, smart phones, web enabled phones, pagers, and PDAs. Also, the communications are messages such as one or more of text messages and multimedia messages. For example, text messages are communicated using asynchronous store-and forward messaging technology such as Short Message Service (SMS) or Enhanced Messaging Service (EMS) or Multimedia Messaging Service (MMS) or the like. Moreover, the multimedia messages are communicated using asynchronous store-and-forward messaging technology such as Multimedia Messaging Service (MMS) or the like.

The group management module of the invention is preferably configured to create association links between telecommunication devices by transmitting an invitation from a telecommunication device as invitor to one or more additional telecommunication devices as invitees and maintaining the association link between invitor and each invitee. The group management module may be configured to identify the group with a unique group ID. It may also be configured to perform one of the following actions upon receipt of an invitation: accept addition to group, decline addition to group, hold decision regarding group until a later time, with the default action being accepting addition to the group. To maintain the association link between invitor and each invitee, the preferred embodiment of the invention stores invitor identifying information on each invitee device and stores invitee identifying information on invitor device. The identifying information preferably comprises information necessary to connect for transmission and reception of communications. In further embodiments, the group management module is configured to assign one or more telecommunication devices with management functionalities comprising one or more of originating the group, administering the group, and controlling transmitting of invitations by all telecommunication devices in the group using a permissions-based mechanism.

In an aspect of the invention, the association links between telecommunication devices form a tree of invitees such that one telecommunication device is the root and one or more invitees are organized into a pseudo-tree topology such that each invitee within the tree references its invitors as parents and its invitees as children. Thus, one or more paths for transmission and reception of communications are established throughout the tree of invitees. Also, in an embodiment, a secondary path for transmission and reception of communications may be established between one or more telecommunication devices with management functionalities and each invitee. The secondary path is established by storing the identifying information of one or more telecommunication devices with management functionalities on each invitee device and storing invitee identifying information on the device of one or more telecommunication devices with management functionalities.

A number of different resources may be stored on the devices. The stored resources are maintained on storage space allocated on the telecommunication device for publishing purposes. For example, in an embodiment, the resources stored on the plurality of telecommunication devices comprise articles of commerce. In that case, the invention further includes a transaction module configured to facilitate transmission and reception of communications for commerce transactions, thereby allowing searching of articles of commerce on all the plurality of telecommunication devices without relying on a centralized server or physical network or wireless network for storing resources, the transaction module further comprising a commerce engine for receiving and processing orders. The commerce engine may include search functionality separate form the search engine. It may also include a bidding engine for auction related transactions, wherein the bidding engine may also include search functionality separate from the search engine. As examples, the transaction module may provide for the purchase and sale of articles of commerce or the auction of articles of commerce.

Alternately, the resources stored on the plurality of telecommunication devices may comprise digital content. A social networking module could then be configured to facilitate transmission and reception of communications for social networking, thereby allowing creating and searching of digital content on all the plurality of telecommunication devices without relying on a centralized server or physical network or wireless network for storing resources.

In an aspect of the invention, the search query includes identifying information to allow the results of the search query to be sent directly to the originating telecommunication device. Moreover, each telecommunication device may include a user-defined access policy for authorizing access to all or part of the resources stored on the telecommunication device by other telecommunication devices in the group or a group-wide access policy for authorizing access to all or part of the resources stored on all telecommunication devices in the group. Also, each telecommunication device may include a user-defined security policy for establishing security parameters needed to access the telecommunication device by other telecommunication devices in the group or a group-wide security policy for establishing security parameters needed to access all telecommunication devices in the group.

In further embodiments, the resources comprise data representing one or more of merchandise, auction items, opinions, classifieds, photos, photo albums, sound files, multimedia data, videos, user profiles, coupons, advertisements, promotional data, documents, numerical data, image data, textual data, contacts and address book data, personal information management (PIM) data, and scientific data.

In an aspect of the invention, transmission and reception of communications uses asynchronous store-and forward messaging technology. The asynchronous store-and forward messaging technology stores communications including search queries and results in the event a telecommunication device is temporarily not operational to receive communications for subsequent delivery.

Other aspects of the invention include having the search engine configured to allow exclusion of telecommunication devices to be searched, the search engine configured to include a time limit for the search to be completed, the search engine configured to allow selection of a list of groups to be searched. The search query may include information identifying the group and/or information identifying the originating telecommunication device.

In an example, the invention may be used for target marketing. In that case, the user profile may include information to identify a user's interests for targeted marketing to a target user. The target marketing includes transmission of target marketing content including one or more of coupons, advertisements, tickets, vouchers, commercial advertisements, classified advertisements to the telecommunication device of the targeted user. Target marketing content is stored on the telecommunication device of the target user as a resource available for searching by other telecommunication devices in the group.

In another example, the search query includes information regarding a specific problem in a defined subject area so that the user of the originating telecommunication device can search for another user of a telecommunication device in the group who is willing to assist in solving the problem in the defined subject area. The search engine may be configured to route a search query to any group of which the originating telecommunication device is a member.

The invention may include additional functions such as logging, record keeping, and reporting for each telecommunication device. Also, a backup utility to a remote server in communication with one or more telecommunication devices may be provided. A user interface is included for each telecommunication device to access group management and search engine functionality.

In a specific embodiment related to the purchase and sale of articles of commerce, the invention comprises an electronic commerce system for controlling transmission and reception of communications for commerce transactions between a plurality of telecommunication devices in a group to provide for the purchase and sale of articles of commerce listed on the plurality of telecommunication devices, comprising (a) group management module for creating and maintaining association links for each of the plurality of telecommunication devices, wherein the association links of all the telecommunication devices in the group represent a logical network of telecommunication devices; and (b) commerce engine for transmission and reception of communications between a plurality of telecommunication devices in a group, the commerce engine configured to route a search query for an article of commerce from an originating telecommunication device along said association links to all telecommunication devices in the group, search articles of commerce listed on the plurality of telecommunication devices, return results of the search query to the originating telecommunication device, transact a sale of the article of commerce, thereby allowing commerce transactions for articles of commerce listed on all the plurality of telecommunication devices without relying on a centralized server or physical network or wireless network. The group management module may further include security and group access control functions.

In a specific embodiment related to auction transactions, the invention comprises an electronic auction system for controlling transmission and reception of communications for auction transactions between a plurality of telecommunication devices in a group to provide for auctioning of articles of commerce listed on the plurality of telecommunication devices, comprising (a) group management module for creating and maintaining association links for each of the plurality of telecommunication devices, wherein the association links of all the telecommunication devices in the group represent a logical network of telecommunication devices; and (b) auction engine for transmission and reception of communications between a plurality of telecommunication devices in a group, the auction engine configured to route a search query for an article of commerce from an originating telecommunication device along said association links to all telecommunication devices in the group, search articles of commerce listed on the plurality of telecommunication devices, return results of the search query to the originating telecommunication device, transact an auction of the article of commerce, thereby allowing auction transactions for articles of commerce listed on all the plurality of telecommunication devices without relying on a centralized server or physical network or wireless network. The auction engine transacts the auction of the article of commerce with functionality to create and view and maintain one or more of bidding merchandise information, bidding history, bidder information, bidder history, winner information, observer information, and merchant information. The auction engine also provides functionality for a bid merchant to create a bid store front with one or more articles of commerce on the bid merchant's telecommunication device available for auction such that bidding for said articles of commerce is transacted on the bid merchant's telecommunication device, wherein the bidding process on the bid merchant's telecommunication device comprises receiving one or more bids from one or more bidders, adjusting the price of the article of commerce to an updated bid price, notifying all other bidders and observers of the updated bid price, ending the bidding process based upon one or more predetermined conditions, and notifying bidders and observers of the winning bidder.

In certain embodiments, the auction system also includes one or more functionalities of time stamping bid notifications from a bidder, implementing contention resolution procedures, security functions, blocking functions, privacy functions, encryption functions, group bidding, merchant rating, reporting, logging, generating coupons for merchandise items, delivering coupons, obtaining customer registrations for future interested items, generating invoices, integrating with a server to perform synchronization tasks, communicating with an order processing system to fulfill orders, transferring merchandise, transferring inquiries, email interfacing, output peripheral interfacing, receiving store front templates and pre-loaded store fronts, migration of data to another telecommunication device, integration with online auction sites such that placing a bid on the online site will result in notification to the telecommunication device. Moreover, the auction engine may further provides functionality to allow a bidder to automatically place the bids with the bid merchant in predetermined increments until reaching a predetermined maximum bid. The auction system also may include a commerce engine for providing one or more functionalities of payment processing, confirmations, shipment processing.

In a specific embodiment related to social networking, the invention involves a social networking system for controlling transmission and reception of communications between a plurality of telecommunication devices in a group to allow searching of resources stored on the plurality of telecommunication devices, comprising (a) group management module for creating and maintaining association links for each of the plurality of telecommunication devices, wherein the association links of all the telecommunication devices in the group represent a logical network of telecommunication devices; and (b) search engine for transmission and reception of communications between a plurality of telecommunication devices in a group, the search engine configured to route a search query for resources from an originating telecommunication device along said association links to all telecommunication devices in the group, search resources on the plurality of telecommunication devices, and return results of the search query to the originating telecommunication device, thereby allowing social networking and searching of resources of all the plurality of telecommunication devices without relying on a centralized server or physical network or wireless network.

As a method for controlling transmission and reception of communications between a plurality of telecommunication devices in a group to allow searching of resources stored on the plurality of telecommunication devices, the invention comprises creating and maintaining association links for each of the plurality of telecommunication devices, wherein the association links of all the telecommunication devices in the group represent a logical network of telecommunication devices; controlling the transmission and reception of communications between a plurality of telecommunication devices in a group, comprising routing a search query from an originating telecommunication device along said association links to all telecommunication devices in the group, searching stored resources in all telecommunication devices in the group, and returning results of the search query to the originating telecommunication device, thereby allowing searching of stored resources on all the plurality of telecommunication devices without relying on a centralized server or physical network or wireless network for storing resources.

As a computer program product, the invention comprises a computer storage medium having a computer program therein for controlling transmission and reception of communications between a plurality of telecommunication devices in a group to allow searching of resources stored on the plurality of telecommunication devices, the computer program performing the steps of: creating and maintaining association links for each of the plurality of telecommunication devices, wherein the association links of all the telecommunication devices in the group represent a logical network of telecommunication devices; and controlling the transmission and reception of communications between a plurality of telecommunication devices in a group, comprising routing a search query from an originating telecommunication device along said association links to all telecommunication devices in the group, searching stored resources in all telecommunication devices in the group, and returning results of the search query to the originating telecommunication device, thereby allowing searching of stored resources on all the plurality of telecommunication devices without relying on a centralized server or physical network or wireless network for storing resources.

The invention also includes a method of directly searching content stored on a plurality of telecommunication devices in a pre-established group, comprising for all telecommunication devices in the group, establishing at least one communication path sufficient to route communications between all devices in the group, wherein the pre-established group is configured by creating association links between telecommunication devices and the path follows the links; and controlling transmission and reception of communications between all devices in the group so that a search query from an originating telecommunication device is routed to all telecommunication devices in the group and replies to said query are returned to the originating telecommunication device, thereby enabling searching of stored content on all telecommunication devices in the group without relying on a centralized server or physical network or wireless network.

An aspect of the invention also includes a method for creating and maintaining a linked group of telecommunication devices to allow searching of resources stored on all of the telecommunication devices in the group, comprising: (a) establishing one or more telecommunication devices with management functionalities; (b) assigning a unique group ID to identify the group; (c) creating association links between telecommunication devices by transmitting an invitation from a telecommunication device as invitor to one or more additional telecommunication devices as invitees, wherein the first invitation is sent by one of the telecommunication devices with management functionalities; and (d) maintaining the association link between invitor and each invitee by storing invitor identifying information on each invitee device and storing invitee identifying information on invitor device, wherein the association links of all the telecommunication devices in the linked group represent a logical network of telecommunication devices such that one or more paths for transmission and reception of communications are established throughout the association links. This method may further include storing on an online searchable site definitional data that provides summary information about the resources stored on one or more of the telecommunication devices in the group to allow a user of the online searchable site to contact the group for full access to the resources.

An aspect of the invention also includes a method of directly searching content stored on a plurality of telecommunication devices in a pre-established group, comprising receiving a search query from an originating telecommunication device; if the search query was not already processed, processing the search query by verifying authorization to search, and if authorized, searching content on the telecommunication device and replying if content on the telecommunications device matches the search query; and if the search query was not already processed, propagating the search query to a subset of devices in the group through pre-established links between group members until the search query is propagated to all telecommunication devices in the group, thereby enabling searching of stored content on all telecommunication devices in the group without relying on a centralized server or physical network or wireless network.

Another aspect of the invention also includes a method of using asynchronous store-and-forward messages for transmitting application specific tasks to be implemented by one or more applications stored on a plurality of telecommunication devices in a pre-established group, comprising: for all telecommunication devices in the group, establishing at least one communication path sufficient to route communications between all devices in the group, wherein the pre-established group is configured by creating association links between telecommunication devices and the path follows the links; and controlling transmission and reception of communications between all devices in the group so that an application specific task sent from an originating telecommunication device is routed to all telecommunication devices in the group, the application specific task containing code necessary to implement application specific tasks directed to applications on the telecommunication devices in the group receiving the task, thereby enabling application specific tasks to be implemented on all telecommunication devices in the group without relying on a centralized server or physical network or wireless network. The application specific task may comprise searching digital content within an application on one or more of the telecommunication devices in the group. The application specific task also may include one or more command codes to direct an application on the telecommunication devices in the group to perform a task, the task comprising one or more of synchronizing, data backup, alert notification, and searching.

Another aspect of the invention includes a method of locating remote resource data available on one or more telecommunication devices through an online search site, comprising composing meta data summarizing remote resource data; associating meta data with one or more telecommunication devices in a group having the remote resource data stored thereon; storing meta data on an online search site available for searching by visitors to the online search site; and providing contact information for one or more telecommunication devices in a group having the remote resource data associated with the meta data to visitors of the online site, thereby allowing visitors to locate remote resource data available on one or more telecommunication devices without storing the remote resource data on the online search site.

Another aspect of the invention includes a method of using a plurality of telecommunication devices in a pre-established group as a router to route asynchronous store-and-forward messages between members of the group, comprising: for all telecommunication devices in the group, establishing at least one communication path sufficient to route communications between all devices in the group, wherein the pre-established group is configured by creating association links between telecommunication devices and the path follows the links; and controlling transmission and reception of communications between all devices in the group so that messages from an originating telecommunication device are routed to all telecommunication devices in the group without relying on a centralized server or physical network or wireless network.

Another aspect of the invention includes a method of using asynchronous store-and-forward messaging to create a virtual network of telecommunication devices in a group, comprising for all telecommunication devices in the group, establishing at least one communication path sufficient to route asynchronous store-and-forward message communications between all devices in the group, wherein the pre-established group is configured by creating association links between telecommunication devices and the path follows the links; and controlling transmission and reception of asynchronous store-and-forward message communications between all devices in the group so that message communications from an originating telecommunication device are routed to all telecommunication devices in the group without relying on a centralized server or physical network or wireless network, said message communications configured to provide one or more functionalities of searching, sending results, propagating queries, group management, and conducting commerce between all devices in the group.

Other aspects and advantages of the invention will become apparent from the following detailed description taken in conjunction with the accompanying drawings, illustrating, by way of example, the principles of the invention.

All patents, patent applications, provisional applications, and publications referred to or cited herein, or from which a claim for benefit of priority has been made, are incorporated herein by reference in their entirety to the extent they are not inconsistent with the explicit teachings of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram of examples of a) how mobile phone users share information among themselves using a server/intermediary b) point-to-point sharing between two mobile phones, as in the prior art.

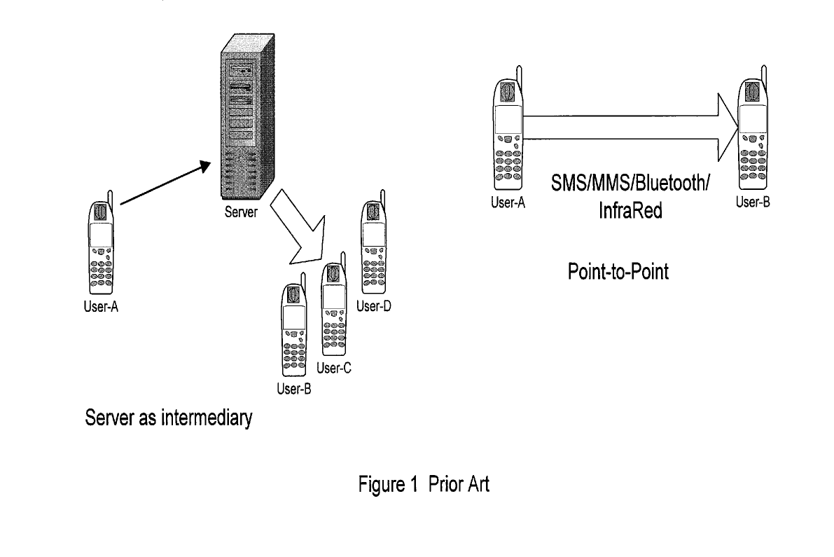

FIG. 2 illustrates an embodiment of delivering store-and-forward messages from one mobile phone to other.

FIG. 3.1 illustrates an embodiment of a general system diagram of the Search Engine and its association with external applications.

FIG. 3.2 illustrates the general process of sending a query request from mobile phone A, and query request processing on mobile phone B.

FIG. 3.3 illustrates a sample result processing mechanism when a mobile phone receives a result.

FIG. 4.1 illustrates a sample group creating and group joining process among mobile phones A, B, C and D.

FIG. 4.2 illustrates a general method of query propagation within a group.

FIG. 4.3 illustrates a general method of query propagation across groups.

FIG. 5.1 shows the commerce engine coupled with the search engine so that the search engine can perform search on merchandise items.

FIG. 5.2 illustrates a general method for searching merchandise items and placing an order on an item.

FIG. 6 shows an embodiment of bidding process.

FIG. 7 shows a general process for applications to publish their digital content and make it available for search engine.

FIG. 8 shows example security policy and access policy tables.

FIG. 9.1 shows an example of discovery query propagation.

FIG. 9.2 shows an example of application-to-application sharing across two mobile phones using common sender and receiver modules.

### DETAILED DESCRIPTION OF THE INVENTION

Referring now to the drawings, the preferred and alternate embodiments of the present invention will be described. As discussed in more detail herein, the invention comprises a method, system, and apparatus for controlling transmission and reception of communications between a plurality of devices in a group to allow searching of stored resources on the devices, including group management and a search engine, thereby allowing searching without relying on a centralized server or physical network or wireless network for storing resources.

The invention focuses on distributed search technology for mobile phones which enables users to discover and share published information among a group of mobile phones without connecting to a network and/or without storing information on a server or intermediary. The search technology may be based on asynchronous store-and-forward messaging techniques, or similar techniques.

Specifically, the invention comprises a personalized search technology for a group of mobile phones where users will be able to dynamically discover digital content (pictures, videos, documents, contacts and other application specific digital data) stored on other mobile phones of the group, without having to store the content on the Internet or any type of network (LAN, WAN, Extranet, Intranet, peer-to-peer network, ad hoc networks, Personal Area Networks (PAN) using BlueTooth, InfraRed, ZigBee and other type of computer networks formed using other wired and/or wireless technologies), and without having to store the digital content on a server or intermediary. Mobile phone users can selectively publish information that they are willing to share with other members of the group. Members of the group are able to instantaneously search published information on other phones of the group and retrieve the published information to their respective phones. The entire process happens seamlessly without user involvement (except when the user is initiating the search request), without storing any information from the phone to the Internet or any intermediaries (data servers), and without the phones being always connected to the Internet or any network. In order to protect user privacy and safeguard information security, users may be limited to only searching within established and secured groups. Groups are created seamlessly by the users with their phones; invitations to join a group may be propagated by any person to any number of individuals, and a phone can belong to multiple, segregated groups. As long as the phone belongs to a group, the user will be able to search all the phones within that group, in accordance with access policies.

In addition to search technology, the invention includes a suite of applications that enable users to create and publish the following types of digital information on their phones: merchandise, auction items, opinions, classifieds, photo albums, profile and coupons, and the like. Moreover, users will be able to publish content created by other applications—contacts information created by Address Book application, documents created by Mobile Office applications, and other digital content created or used by other applications. Using their mobile phones, not only will the users be able to search for digital content, but also will they be able to conduct person-to-person commerce (direct selling, bidding and other commerce related tasks) within groups.

Throughout this invention description, we refer to mobile phones. However, this invention is not necessarily specific to mobile phones. It is applicable to any device that is capable of sending and receiving asynchronous store-and-forward type messages. Currently mobile phones are equipped with this technology, and in the future some other devices might be equipped with this, or a similar, technology.

The method, system, and apparatus of the present invention provides the ability to create, to publish, to search, and to retrieve published information (merchandise, photo albums, auction items, classifieds, opinions, and the like) on the mobile phones, without the need to store the information on the Internet (World Wide Web) or any local area network server or any other intermediary. This emphasizes the fact that a user does not need to transfer/upload information from the mobile phone, and store that information on a server/intermediary for the purpose of being discovered by others. There is no need to query a server/intermediary for the required information. With our approach, information is instantly available for searching when it is published on the mobile phone; consequently, users can publish and/or search for digital content at their slightest impulse. A user may create new content and publishes it on their mobile phone using a GUI or by other means. Moreover, existing content can be published using the GUI or by other means. There is no need to learn any web technologies (HTML, XHTML, ASP, Java Script and so on) to publish information on their mobile phones. Key words can be associated with the content. Once the content is published, it is ready to be discovered by other mobile phone users.

The method, system, and apparatus of the present invention provides the ability to discover and retrieve published information without being (and/or staying) connected to a LAN or WAN or Internet or Intranet or Extranet or P2P Network or ad hoc networks or Personal Access Networks (PAN) using cable, Bluetooth, Infrared, ZigBee and other wired/wireless technologies. This invention focuses on devices that are not connected to these types of networks, so that in order to discover information, the mobile phone need not be connected to some type of a network. Since the proposed method of searching for information does not depend on a network or a server/intermediary, mobile phone users will be able to simultaneously search mobile phones provided by different operators (T-Mobile, Cingular, Verizon and so on) and/or manufacturers (Motorola, Sony Ericsson, Nokia and so on).

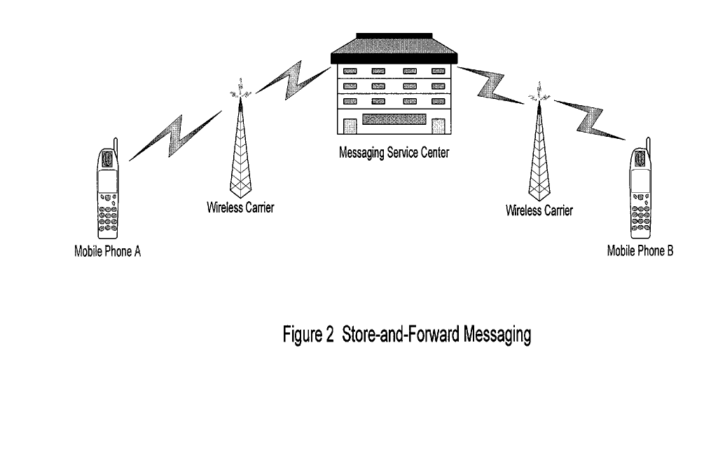

For a better understanding of the invention, it is important to note the difference between synchronous and asynchronous communication. Asynchronous operations are non-blocking. This means that the sender of the message only initiates the operation, and does not have to wait for a response. If and when a response does appear, the application can receive that message and respond to it appropriately. This is the opposite of synchronous operation, which blocks the process until the operation is completed. In synchronous operation, the application is on hold until the operation is finished. An example of synchronous communication is Internet application. Once a web page is requested, users have to wait until the content comes back before they can continue working. Asynchronous messaging technologies such as SMS (short messaging service), EMS (enhanced messaging service), and MMS (multimedia messaging service) have store-and-forward capabilities. When a message is sent, it will not directly go to the intended recipient directly. As shown in FIG. 2, when a message is sent by mobile phone A, the message is stored in a message service center and the message is delivered when the recipient (mobile phone B) is available or ready to receive the message. This is significantly different from non-store-and-forward messages where the message is directly sent to the recipient and the message is lost if the recipient is not available. For example, TCP and UDP messages and Instant Messenger (IM) messages are all non-store-and-forward messages, and these technologies are limited to work in a networked environment. SMS, EMS and MMS are standard store-and-forward messaging techniques which are asynchronous by nature, and are currently offered by mobile phone operators to their subscribers.

In our proposed method, during the search process, communication between mobile phones occur using store-and-forward messaging—SMS (short messaging service), EMS (enhanced messaging service), MMS (multimedia messaging service) and other types of store-and-forward messaging techniques. By default, store-and-forward messages are asynchronous in nature. For the purposes of clarity, they will be referred to herein as asynchronous store-and-forward messaging. Throughout this invention, when referring to messaging (or messaging techniques), it is preferably an asynchronous store-and-forward messaging technique. It is important to note that the invention contemplates use of any type of asynchronous store-and-forward messaging, not just limited to SMS/EMS/MMS, and includes proprietary messaging such as Nokia Smart Messaging. In this manner, there are no geographical boundaries—since messages can be sent to any phone and they are not connected to any network, there is no geographical limitation to send a message. Mobile phones can be connected to a network (Internet, Extranet, Intranet, Personal Access Network and so on), and still they can use asynchronous store-and-forward messaging to discover and retrieve information.

There are several reasons for using a mobile phone as a search platform to discover information. Current mobile phones have enormous amount of computing power and storage, and they have evolved into powerful social computing tools that users can carry with them at all times. Some mobile phones can store several hundred mega bytes of data capable of storing more than 500 songs, more than 1000 pictures, and more than 1000 contacts. The recent innovations in mobile phones have enabled users to store large amounts of information on them. In general, for sharing or other purposes, users do not transfer their mobile phone content to a server on a regular basis, because it is a tedious and inconvenient task. Moreover, users do not keep their mobile phones always connected to the Internet or any type of network. Currently, more and more users are using mobile phones for non-talking purposes—taking pictures, storing information, taking videos, sending messages and so on. A mobile phone is a very impulsive device, and since users always carry their mobile phone, it is easier for them to use them at their slightest impulse. On another note, people are great source of information—particularly, our friends, family members, and association/community members. People, whom we know directly or indirectly through our associations, are reliable providers of information. People carry so much wisdom that current Internet search techniques or server based search techniques does not tap into people's wisdom to discover relevant information. Current online searches are similar to finding a needle in a haystack and the results are neither reliable, nor relevant to users' search requests. Our invention is based on a simple premise—let mobile phone users, rather than going to a network to find information, find people or other mobile phones which can provide relevant information, so that mobile phones become reliable and relevant information providers to others.

In the proposed method, the user is limited to search within established groups. One big advantage of groups is that the user need not know every person's information in a group to search all the mobile phones in a group. As long as the user is a member of the group, the user is able to search all other phones in the group. For instance, a user with a camera phone belonging to a professional association takes pictures of his/her vacation in London. In order to share his/her pictures with others members of the association, he/she does not have to transfer the pictures to a web site, but simply publishes the pictures on his/her mobile phone. If some other member in the association wants to know anything about London or planning a vacation in London, without going to the Internet, the member will be able to search other members' mobile phone and discover this information about London.

As another example, a real estate agent on the West coast can search his/her colleagues mobile phones on East coast for any East coast listings. In this scenario, the real estate agent on East coast takes a picture of a property with his/her camera enabled mobile phone and publishes it on his/her mobile phone. Eventually, his/her colleague on West coast will be able to discover this listing and directly retrieve this information to his/her mobile phone. This offers great convenience for both the searcher and the provider of information: no need to transfer information to a server, no need to deal with connectivity issues, no need to worry about losing messages, and no need to push information to the receiver. The process of searching and sending results are automatically handled with almost zero human intervention. Asynchronous store-and-forward messaging is the most suitable form of communication for searching mobile phones, because unlike servers, mobile phones could go offline for extended duration (users go out of range, turn off their phones, battery dies and so on) and users can initiate search requests at any time and from any place. By using asynchronous store-and-forward messaging techniques, the search requests/results are guaranteed to be delivered to the intended recipients.

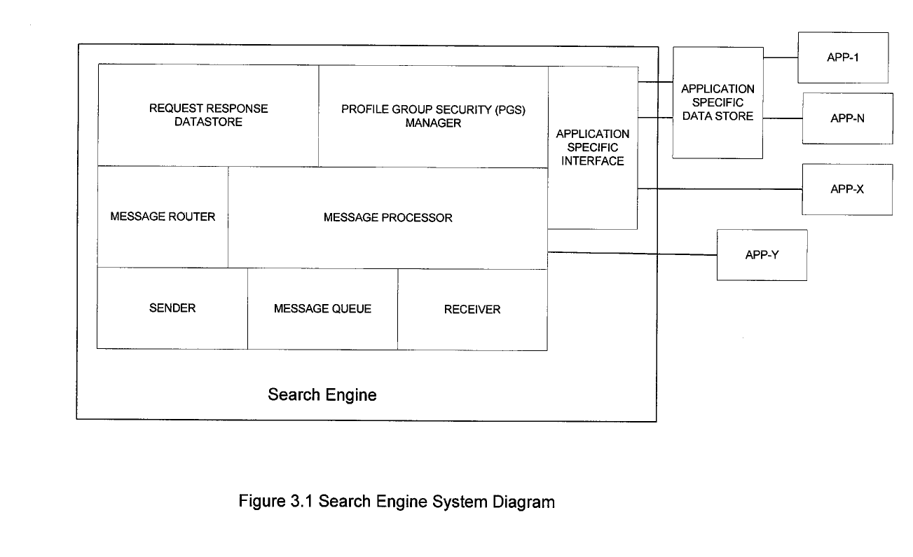

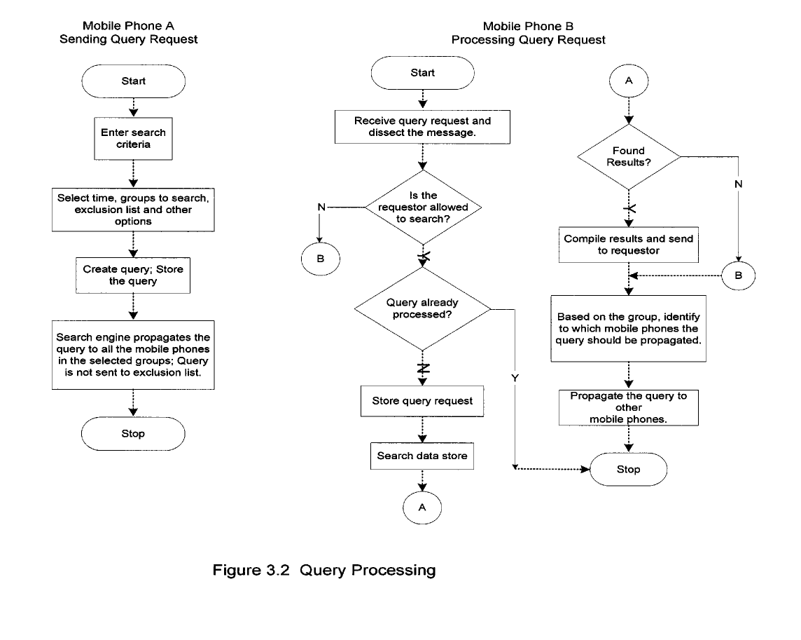

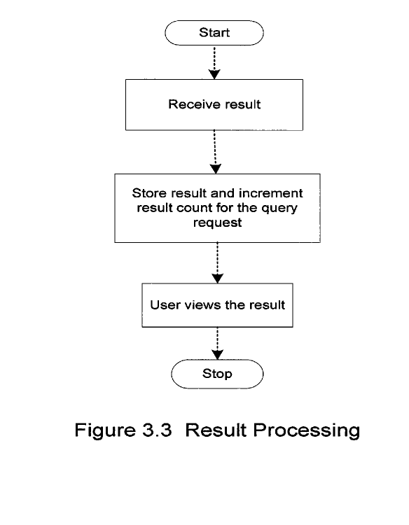

FIG. 3.1 illustrates an embodiment of a general system block diagram of the Search Engine of the present invention and its association with external applications. Several such embodiments can exist. Additional components can be added later as known in the art and are not limited to what is shown. Referring to FIGS. 3.1-3.3, FIG. 3.2 illustrates the general process involved in creating and sending the query request by mobile phone-A to other mobile phones. FIG. 3.2 illustrates the general process when a mobile phone-B receives a search request. FIG. 3.3 illustrates a sample result processing mechanism when a mobile phone receives a result.

In use, as generally shown in FIG. 3.2, a user of Mobile Phone A composes a query using the GUI or by other means, provides a search criteria (search string and/or search category and/or any combination using Boolean operators), selects the groups to search, sets time limit, selects mobile phones from exclusion list (mobile phones that should not be searched) and initiates the search request. The query request message preferably contains all the necessary details (search criteria, sender information, group information, time limit and so on) to do the search. The query request message is sent to all the members of the selected groups. Based on asynchronous store-and-forward messaging techniques, the query request message is stored in the service center and the service center will deliver the message to the destination mobile phone.

Turning now to FIG. 3.2, Mobile Phone B, when the mobile phone receives the query, it will do the search and if the results are found it will forward to the requestor. It may then propagate the query request to other members of the group. Since query requests and results are sent using asynchronous store-and-forward messaging techniques, if the mobile phone is turned off or out of range, the message will be stored in a service center and later on it will be forwarded to the mobile phone when it is turned on or becomes operational. Hence, no query requests or results will be lost due to a device being turned off or out of range. There is no need for the mobile phone to be connected to a network during the entire process; therefore, the mobile phone doesn't have to maintain network connections and deal with all the issues associated with network connection management. When a search request is sent to a group of mobile phones, since all communication occur using asynchronous store-and-forward messaging, the messages arrive at their destinations at different times. After the sender initiates the query, unlike synchronous query, he/she does not have to wait for the results as results will arrive in due course.

In a specific embodiment, the method, system, and apparatus of the present invention provides a Distributed Search Engine for mobile phones that allows searching/discovering published information in other mobile phones using asynchronous store-and-forward messaging techniques. The search engine acts as a transceiver (receiver of messages and transmitter of messages) and as a router, that intelligently and asynchronously propagates the messages to other mobile phones within a group. The search engine may be implemented as a software application that resides on the mobile phone.

Preferably, in some embodiments, the search engine will be running as a software application/module in the background of the mobile phone software system. User can launch the search engine using a GUI or the search engine is automatically launched whenever the mobile phone is turned on. In some instances, the mobile phone operating system or the mobile phone software platform system or mobile phone message receiving system will launch the search engine as soon as it receives a message that is intended for the search engine.

The main functionalities of the search engine include but are not limited to: (1) Searching published information, (2) Composing results, (3) Sending messages—search requests, search results and other application related messages, (4) Receiving messages—search requests, search results and other application related messages, (5) Routing messages to other mobile phones, (6) Processing application specific messages, (7) Performing certain security, group and profile related functionalities and other administrative tasks, (8) Storing messages, (9) Logging and record keeping for auditing purposes, (10) Reporting, (11) Communicating with servers to back up information.

A user interface is provided to the search engine to initiate search queries, to view messages/requests/results, and to perform other operations.

In a specific embodiment, as shown in FIG. 3.1, the core components of the search engine include but not limited to the following: (1) Message Receiver—receives messages from other mobile phones and places in the message queue. (2) Message Queue—place holder to store messages in a first-in-first-out fashion. (3) Message Processor—fetches messages from the message queue, dissects the message and processes the message based on the message type. Query request messages will be interpreted to search published information; Result messages will be interpreted as results sent by other mobile phones in response to a search request that was initiated earlier; Application specific messages are interpreted as messages directed to specific applications. (4) Message Router—based on proprietary asynchronous routing algorithm, the message router determines the mobile phones to which the message should be propagated. (5) Message Sender—sends messages to the appropriate mobile phones using one of the asynchronous store-and-forward messaging techniques. (6) Request and Response Data store—storage system to store requests and results. Data Store can be any storage system that enables storing data on a permanent basis on the mobile phone. (7) Profile, Group and Security Manager (PGS Manager)—system that provides mechanism to apply security, store user profile and settings, perform group related functionalities and other administrative tasks. (8) Interfaces to application data store—used by the message processor to search information stored by other applications. For example, App-1 and App-N as shown in the FIG. 3.1. (9) Interface to other applications—used by various components to access other applications and/or enable other application specific tasks and/or modify other application related content. Interface to App-X as shown in the figure. (10) Direct contact to applications—used by the message processor for direct communication with an application and vice versa. For example, Message Processor to App-Y as shown in the figure.

As described in more detail (with reference again to FIGS. 3.2 and 3.3), the user creates a search query using the GUI. During this process, the user provides search criteria, specifies groups to search, time limit and other options as provided by the GUI. Sometimes, user selects a list of users from the Exclusion List. Exclusion List is a list of mobile phones which will be excluded during the search process; as a result, the query request will not be propagated to these mobile phone listed in the exclusion list. This exclusion list can be stored as part of the user profile or user security, or the user might manually specify this exclusion list every time a query is initiated, or the user might select/deselect a list of users every time a query is initiated. A query packet is created and placed in the message queue. The Message Processor retrieves the message, processes the message, stores the request and propagates to all the group members from the selected list. The search request is not sent to the exclusion list numbers.

A user can create and maintain another list of users called ‘Block List’—a list of users who are not allowed to search the mobile phone irrespective of their group membership. The PGS manager uses this block list while processing search requests. The search engine will not search unpublished digital content. In other words, only published information can be discovered by other members of the group. The user uses a GUI to publish/unpublish digital content stored on the mobile phone. The user can modify the publishing status (publish/unpublish) of the digital content at any time. The user may track the queries and view the results associated with the queries using a GUI.

Referring to FIG. 3.2, when a mobile phone receives a search request, the receiver component places the message in the message queue. The message processor retrieves the message and dissects the message to read its contents. The security manager checks for permissions and performs the necessary checks and validations, so that the original requestor of the query has the necessary permissions and privileges to complete the search operation. If the security check fails, the search request will not be processed and the user might be alerted about certain security violations. Depending on the violations, the user might take certain actions. If a search request passes security tests, the message processor will check whether the query has already been processed or not. It is quite possible for a mobile phone to receive the same search query multiple times as a result of query propagation. If the query has already been processed, the message processor will remove the message and stop its execution. Otherwise, the query request will be stored in a data store and the message processor uses the search criteria to search the data store.

The message processor uses application specific interfaces to do the search. Sometimes, the search might be done without using the application specific interfaces. Depending on the search criteria, the message processor chooses the appropriate application specific interface to perform the search. Each application specific interface is aware of the intricacies associated with the data, data source details, structure of the data and so on. The search logic may be implemented by the interface or by the search engine itself. The search logic may use currently available search techniques or other techniques that may be specific to mobile phones. If there is any information that satisfies the search criteria, the message processor creates a results packet and directly sends the result(s) to the original requester. The results packet can contain all the details but not limited to: information about the sender, result (combination of text and/or any type of digital content), and so on.

The message router then identifies the next set of mobile phones that it needs to propagate the search request. In order to do so, it will use the group information that was passed in the search request and intelligently determines the next set of mobile phones to which the request should be propagated. The sender component will then propagate the search request to the identified mobile phones.

Using a GUI, the user may view, track and perform maintenance tasks on the search requests that were processed by the mobile phone. All requests processed by the search engine can be logged. Log information can be anything but not limited to: path traversed by the search request, time required for processing, security violations and so on. The user can view all the details using the GUI. Reporting functionalities might be implemented and reports can be generated using a GUI. The user can perform maintenance tasks on the reports using the GUI. The reporting functionalities can be added as an extension to the search engine or it can be installed as a stand alone application to execute independently outside the search engine.

As shown in FIG. 3.3, when the original requestor of a query receives the result, the message processor stores the result, and increments the results count for that query. The user views the result using a GUI. Whenever a result arrives, the user may be alerted in different ways such as: making a sound, sending an email, sending a page message and other. The search engine might include certain exception handling and error processing functionalities to deal with uncertain behaviors, errors, unusual activities and abnormal program execution.

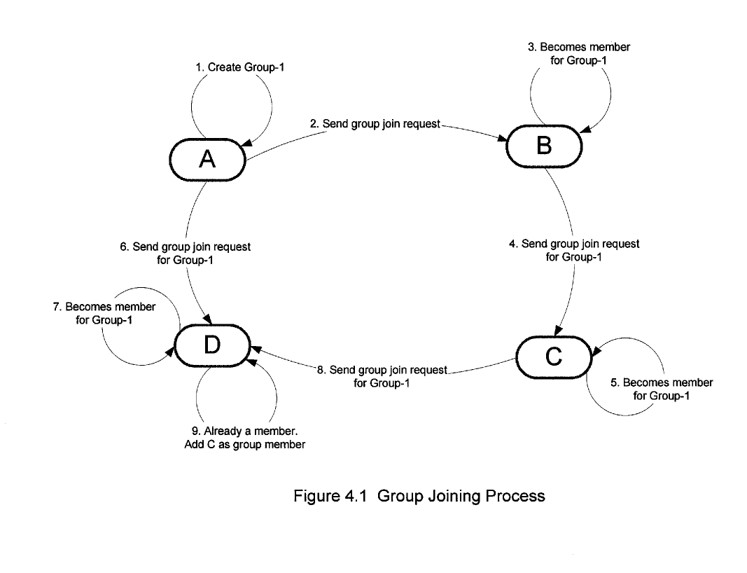

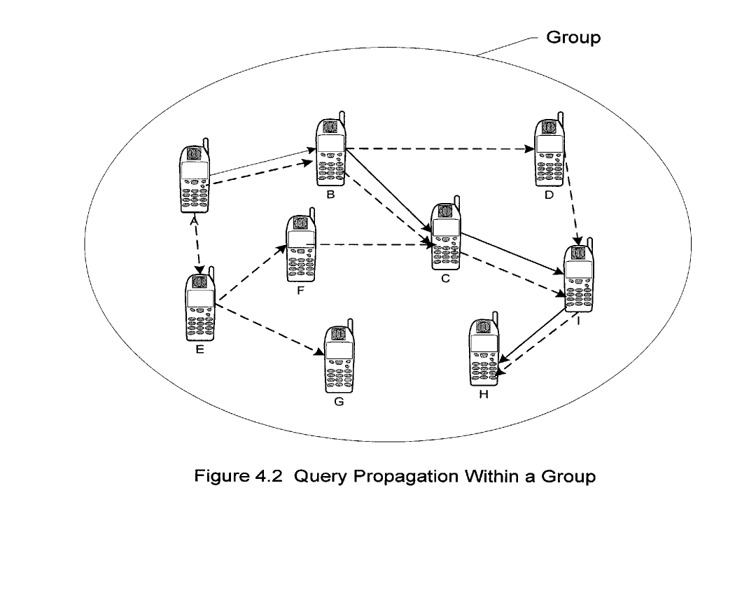

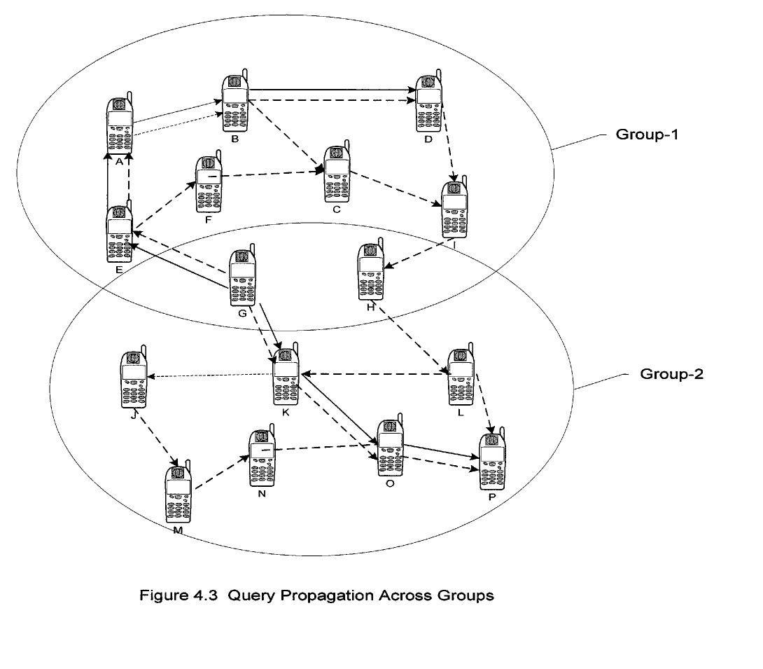

The method, system, and apparatus of the present invention also provides for creating groups and searching within the groups with reference to FIG. 4.1. The concept of groups will allow sharing information with specific users. Specifically, a mobile phone is a very personal device and information stored on the mobile phone is very personal to the user. Users do not prefer any intrusions of any type into their mobile phones. Unlike Internet, where everyone can access any published information, mobile phone users prefer sharing information stored on their phone with specific people only. A group, therefore, defines a logical boundary for the search domain and the search space is limited to the mobile phones belonging to a group. It specifies the search boundary for the search engine. On behalf of the original requestor, the search requests are propagated to other mobile phones belonging to that group; hence, a user cannot initiate a search request without being a member of a group.

Group information is not stored in a centralized database; rather, all the information is stored on individual mobile phones. Groups are created by sending asynchronous group-join requests to any number of people by any person. A group member does not have to be aware of all the members in the group, nor the size of the group; however, a group member will be able to search all the phones in the group. A user can belong to multiple groups and search in multiple groups. As long as the user is a member of a group, the user will be able to discover published information from any phone within the group. A group, in its rudimentary form, is associated with a unique group id, group name, group created by person information, and/or group creation date, and/or expiration date and/or other miscellaneous information. If a mobile phone stores certain information about a group, by default, it belongs to that particular group. A user may create groups using a GUI or by other means.

A user can send group-join requests to any person (mobile phone). The person who created the group or a person with group management responsibilities can configure whether other members can propagate group-join requests or not. For instance, when user-A sends a group-join request to user-B, user-A can specify whether the user-B can send group join requests for this group to other users or not. If user-B doesn't have permissions to send a group join request to user-C, and if user-B makes an attempt to send the group-join request, user-B will get a message that he/she cannot propagate the request, and he/she needs to contact the responsible person (in this case user-A) to send the request to user-C. An automatic invite mechanism can be provided where user-A (person with group management responsibilities) is requested by user-B to send group join request to user-C. User-A when he/she receives such requests, can exercise his/her option for further processing.

If user-A wants to send group join request to user-B, user-A selects a group from his/her list of groups or from newly created group on his/her mobile phone, provides user-B's name and number, and sends join request. When a user receives a group-join request, in a preferred embodiment, the user automatically becomes the member of the group. The user who receives the request does not have to do anything extra on his/her part. The group request will be automatically processed by the search engine and enrolls the user into the group. In an alternate embodiment, the joining would not be automatic. In the automatic embodiment, a user can always deactivate or de-list from a group without letting other users or members of the group being aware of his/her decision.

Whenever user-A sends group join request to user-B, user-B automatically becomes a group member and this information is stored on user-A's mobile phone. When user-A sends a group-join request message to user-B, user-A doesn't need to notify other members of the group that a new member will be joining the group. Yet other members of the group will be able to search user-B's mobile phone. Whenever a user receives a group join request, by default, the receiver becomes a member of the group. However, the receiver can do one of the following: (1) Accept—default behavior, (2) Decline—user doesn't become a member and the user may choose to notify the requestor, (3) Hold—decide later; the user can select to accept or decline at a later time, (4) If the receiver is already a member of the group, then the receiver will add requestor's information as the group member on his/her mobile phone.

Every group is internally identified by a unique group id; Group names can be renamed and there can be duplicate group names.

Referring specifically to FIG. 4.1 a sample group creating and group joining process among mobile phones A, B, C and D is shown. User-A creates a group ‘Group-1’ and sends group join request to B. B accepts the request and at a later time sends a group join request for ‘Group-1’ to C. C accepts the request. Now, A sends a group join request to D, and D will accept the request. C is not aware of A sending a group join request to D, and C sends a group join request for ‘Group-1’ to D. Since D is already a member of this group, D just adds C as the member of the group.

Users can belong to multiple groups and users can propagate multiple group-join requests to other mobile phone users. The user may maintain group information using a GUI or by other means. The creator or owner of the group can renew memberships of the group. Besides, they can grant/transfer certain privileges—administrative privileges or group privileges—to certain group members; all these can be done using asynchronous messaging and with limited user intervention. There can be multiple owners to a group. All group operation related messages contain enough and necessary information that identifies the sender and receiver, and to perform the required operation on the receiving side. The message structure and content is dependent on the type of the message and the specific operation required to be performed. Group level access policies can be set using security modules and the user can apply security policies to the groups. Using a GUI on his/her mobile phone, the user may configure whether a particular group has permissions to search and/or retrieve published information or not.

FIG. 4.2 illustrates a general method of query propagation within a group. Dotted arrows indicate the path of group-join request propagation. Solid arrows indicate a query path traversed from the requestor to the source that has the answer. In this figure (FIG. 4.2), mobile phone-A initiates the query and mobile phone-H has the answer. The query request which is initiated by user-A, follow the path: A to B to C to I to H. H finally sends the results directly to A.

FIG. 4.3 illustrates a general method of query propagation across groups. In this scenario, the requester is a member of more than one group—group-1 and group-2. Dotted arrows indicate path of group-join request propagation. Solid arrows indicate a query path traversed from the requestor to the source that has the answer. User-G, who is a member of group-1 and group-2, initiates a query. User-D in group-1 and user-P in group-2 have the result. In group-1, the query request goes thru: G to E to A to B to D, and in group-2 the query request goes thru: G to K to O to P. Users D and P will send the results directly to G. The query path traversed can be non-deterministic and there can be several such multiple paths. FIG. 4.2 and 4.3 show one possible query path.

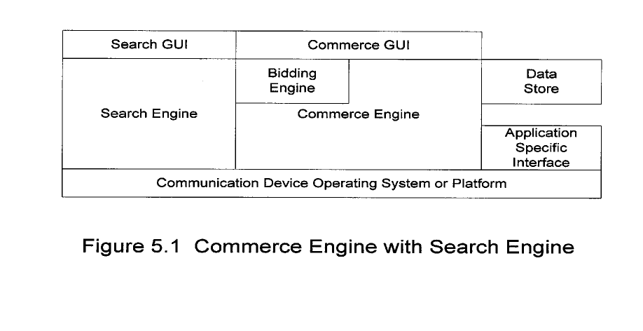

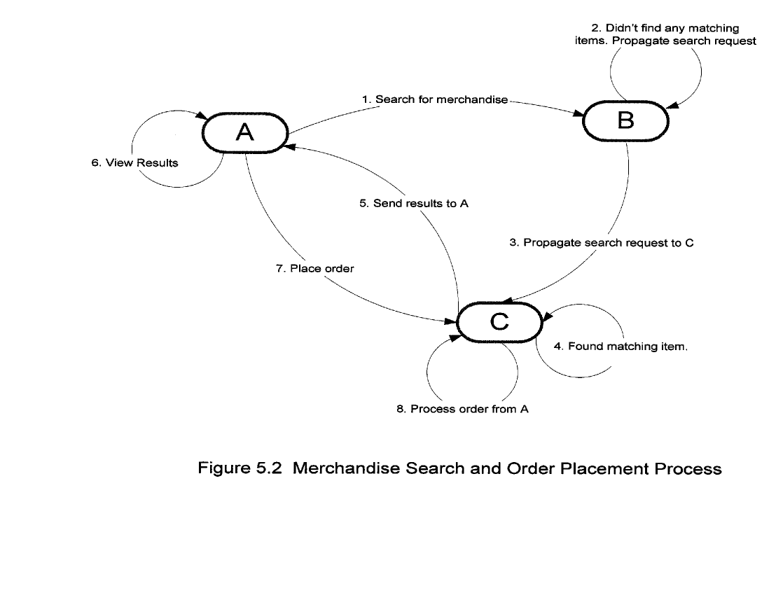

Turning now to FIG. 5.1, the method, system, and apparatus of the present invention also provides a commerce engine for mobile phones and method to conduct person-to-person commerce using mobile phones—a method to conduct ‘Social Shopping’ on mobile phones. The commerce engine enables users to perform person-to-person commerce using mobile phones within groups. Commerce can be any commerce related activity but not limited to direct selling and/or auctioning of products, services, and/or information. The commerce engine uses asynchronous store-and-forward messaging techniques.

Currently, in online commerce applications, the user goes to an online shop, searches for an item, places order, and checks order status and/or cancels item connecting to a network. Current online commerce applications work in synchronous mode—a web page is requested, users have to wait until the content comes back before they can continue working. Besides, all online commerce applications are centralized applications where a client using a browser establishes connection with a server to conduct commerce.

The term ‘Social Shopping’ refers to shopping among social circles. The proposed method enables to perform commerce without connecting to any type of network and in asynchronous mode by using asynchronous store-and-forward messaging technology—a method for conducting ‘social shopping’ on mobile phones using asynchronous store-and-forward messaging technology. The user may create store fronts (regular merchandise and auction items) on a mobile phone, search for merchandise items from a multiplicity of mobile phones, place order, check order status and/or cancel an ordered item without connecting to a network and in asynchronous mode. A user will be able to search for merchandise items on one particular phone or a group of phones. Moreover, the proposed method implements commerce functionalities on a mobile phone which is basically a communication device. By implementing commerce on a communication device, the productivity and efficiency of all the stakeholders will be greatly increased, and opens additional revenue channels for mobile phone operators and mobile phone users.

There are several advantages in providing social shopping features on mobile phones: (1) Trust—gives the buyer more trust with the person he/she is dealing with; because, both buyer and seller belong to a group and/or may know each other and/or have some type of an acquaintance. (2) Easy to communicate—a buyer can easily communicate by calling the person. (3) Confidence and Security—provides buyer confidence and a sense of security that the user is buying from a reliable source. (4) Reduced Time to market—users don't have to upload information to a web site and wait for online shoppers. Users can take pictures of their merchandise using their mobile phone (camera equipped mobile phone), associate a short description, and in no time they will be have a shop front on their mobile phone.

As shown in the FIG. 5.1, the commerce engine is coupled with the search engine so that the search engine can search merchandise items. Using the GUI the user may interact with the search engine and the commerce engine. In this example, a bidding engine is a part of the commerce engine. The commerce engine may provide application specific interfaces for interfacing with other applications. The commerce engine, preferably, uses data store to store commerce content. The commerce engine performs tasks like receiving orders, processing orders, processing bids, and other tasks such as payment processing/handling, managing shipments, processing returns, tracking orders, cancellations, and so on. In addition, it implements the order processing methods on a mobile phone using asynchronous store-and-forward messages. In some implementations, the commerce engine may be separated from the search engine so that it can be executed as a stand along application. In some instances, the commerce engine may implement its own search engine functionalities. Similarly, the bidding engine may be separated from the commerce engine and it may be implemented to execute as a stand-alone application. The bidding engine may implement its own search functionalities.

Using a GUI, the user may create storefront to sell regular merchandise items, and/or auction front to sell auction merchandise items on the mobile phone. The proposed method provides a mechanism for mobile phone users to dispose their used items, garage items, surplus items, antique items, and other items of commerce. The user stores merchandise information (name, description, price, quantity available, shipping and other details, with images, pictures, multimedia files) and publishes it on his/her mobile phone. In some instances, the user may publish his/her business services. Just like online stores, users will be able to search for merchandise items, view results and may place orders.

When the search engine receives a search request to search a merchandise item, the search engine searches all published merchandise items stored in the data store. If a particular merchandise item satisfies the search criteria, the matching merchandise information (text and/or multimedia content) is sent to the requestor as a result message.

FIG. 5.2 illustrates a general method for searching merchandise items and placing an order on an item. A, B and C represent 3 different mobile phones. As shown in the FIG. 5.2, the following is one possible sequence of events: (1) User-A initiates a search request for a merchandise item. The query request is sent to B. (2) The search engine on B's mobile phone performs the search and finds no matching items. (3) B propagates the request to C. (4) The search engine on C's mobile phone performs the search and finds matching items. (5) C compiles the results and sends to A. (6) User-A views the results and decides to place an order on an item. (7) User-A places order and the order information is sent to the merchant C. (8) C processes the order.

On receiving the merchandise search results, the user may do one of the following: (1) Call the merchant directly, and get more information about the product and/or enquire about other products. (2) Place an order—for regular merchandise, the requestor can place an order using a GUI; a message is sent to the merchant and the commerce engine will process the order. (3) Place a bid—for auction merchandise, the requester can start placing bids using the GUI and the bidding engine will process the bids. (4) Be an observer—for auction merchandise, the requester can register as an observer to view the bidding process and receive bidding updates from the merchant.

The user may place an order using a GUI or by other means, and provides the necessary information (quantity required, shipping address, payment information and other details) to place an order. The buyer may associate one or more coupons with the order. This coupon(s) may be delivered by the merchant while sending the merchandise search result and/or it might be sent at some other time, and is currently stored on the mobile phone. In some instances, this coupon may be sent by providers other than the merchant itself. The order information with or without coupon(s) is sent using asynchronous store-and-forward message to the merchant mobile phone. The commerce engine on the merchant mobile phone will process the order. In some instances, the search results may include an expiration date—the date by which the order should be placed by the buyer. The buyer may be limited from placing an order after the expiration date, but sometimes, the merchant may process orders placed after an expiration date.

FIG. 5.2 shows an embodiment of order request processing method. As shown in the FIG. 5.2, the buyer (User-A) places an order providing the necessary details. The order is sent using asynchronous store-and-forward message to the merchant (User-C). The commerce engine on the merchant mobile phone will process the received order. Each order may be associated with a status. In some instances, orders may be processed without associating any status to them. Order status can be anything but not limited to: OPEN, ACCEPT, SHIPPED, CANCEL, CANNOT PROCESS.

In some embodiments, if an order is associated with a status, when a merchant receives an order, the status is set to OPEN. On an open order the commerce engine performs one or more of the following (but not limited to the following): process the order, verify ordered quantity, verify buyer information, verify and apply coupon information, process payment, or update inventory. Some steps may be overridden manually by the merchant and/or may be skipped. The order status is set to ACCEPT and an acceptance message is sent to the buyer. With the order acceptance message, the merchant might include additional digital information such as order id, confirmation number, estimated shipping date, loyalty coupon, repeat business incentives, and any other information.

The buyer can enquire the status of an order with the merchant by sending enquiry messages and the commerce engine will respond to the messages accordingly. Once the merchant ships the merchandise, the order status is changed to SHIPPED and the buyer is notified about the shipment. Certain information about shipment details may be included in the notification message so that the buyer can track the shipment. In some instances, the buyer might place an order using his/her mobile phone, without going thru a series of steps, by just pushing a button on his/her mobile phone or by just clicking on a menu item or GUI option. When a buyer takes this short-curt, all necessary order information, which is already stored in a data store, may be sent to the merchant.

In some instances, the commerce engine implements the bidding process. Specifically, if the merchandise search results return bidding merchandise items, then a buyer can select one or more items, and start participating in the bidding process by placing bids. The bidder places a bid using the GUI or by other means, and sends the bid information to the merchant. The merchant will notify the bidder with bid updates, and if the bidder wins the bid, the merchant will notify the winner, closes the bid, processes payment, and ships the item to the bidder. The merchant uses the functionalities of the commerce engine to complete the transaction after a winner wins the bid.

Users can be observers of the bidding process. Specifically, if the merchandise search results return bidding merchandise items, then a buyer can select one or more items, and register with the bid merchant as an observer of the bidding process. As a result, the bid merchant will notify the bid updates to the observer. Eventually, an observer might participate in the bidding process. The observer may view the bid updates using a GUI or by other means. The observer may notify the bid merchant to stop notifying with the bid updates. Sometimes a user may communicate with the bid merchant and register to start receiving notifications if the bid price reaches a certain price point.

Sometimes the bidding/auctioning functionality can be separated from commerce engine and executed as a separate bidding engine module. The user may decide not to execute the bidding engine if he/she has no items to bid or if he/she is not creating an auction front on the mobile phone. Similarly, the user may decide not to execute the commerce engine and just execute bidding engine on the mobile phone. The commerce engine can be configured to execute on a mobile phone without using the search engine.

The commerce engine may provide mechanisms, application specific interfaces and extensions to add additional functionalities. These functionalities can be anything but not limited to reporting, logging, generating coupons for merchandise items, delivering coupons, obtaining customer registrations for future interested items, generating invoices, integrating with a server or some other device to perform synchronization tasks, communicating with an order processing system to fulfill orders, transferring merchandise and/or enquiries and/or order data to a server and/or to another computing device, and other. These functionalities may be implemented as add-on modules and/or as standalone applications and may be individually or totally integrated with the commerce engine. The commerce engine may provide interfaces to an email system so that emails may be sent to the respective parties whenever an event occurs. The commerce engine may provide interfaces with printers, scanners, fax machines, and/or other output peripherals to output certain digital content. The commerce engine may provide interfaces so that instead of a user manually creating store fronts on the mobile phone, an external application may send message(s) and/or email to the commerce engine, and the message(s) may have enough information to create entire or partial store fronts on the mobile phone. The commerce engine may provide interfaces so that entire or partial store front data, order data, customer information data and other commerce engine related information may be migrated to other mobile phone(s) or devices or server. The migration may occur using any of the available methods but not limited to email, asynchronous and/or synchronous communication mechanisms, Infra Red, Bluetooth and other available methods to transfer data. The commerce engine may expose certain interfaces or act like an intermediary for bidirectional or unidirectional data interaction between the mobile phone and an online shopping engine or online software module or a software component running on a network or a web service. The commerce engine may include certain exception handling and error processing functionalities to deal with uncertain behaviors, errors, unusual activities and abnormal program execution. The commerce engine may include certain security functionalities and/or may interact with a security application or module to enforce security policies. Security violations may be notified to the relevant parties using appropriate procedures. The merchant may block some users to search/view certain merchandise items and/or may restrict certain users from performing certain commerce related tasks. The asynchronous store-and-forward messages may be encrypted using available technologies to protect privacy and identity, and guard transaction secrecy.

The commerce engine may be extended to perform certain group-buying transactions where multiple mobile phone users group together and place orders with a merchant. The mobile phone users will search the required merchandise and communicate among themselves to form a group and then place an order. The merchant mobile phone will receive orders from multiple users who have flocked together to enjoy group-buying advantages. A separate indicator may be incorporated in these orders as an indication for the merchant that these buyers have pooled together to place an order. In some embodiments the merchant may publish merchandise items with tier-pricing information or merchandise items that are exclusive for group buyers.

In some embodiments the commerce engine implements merchant rating functionality where a merchant is rated on several factors such as reliability, trust worthiness, shipping, performance, payment handling, and customer service and other factors. The customers and/or requestors may fill in a scorecard and send to the merchant. The commerce engine computes the scorecard information received by several users, and presents it in a form that is readable and perceivable by other users. It may be presented using any form such as star rating, numerical rating, and pictorial rating and other score card information presentation techniques. This rating information may be associated with all merchandise items, so that whenever a user requests for merchandise information, the rating information may be sent to the requestor with other information. In some embodiments, a user may just send an exclusive message to the merchant to obtain merchant rating information. In some embodiments, a user may send a query request within a group of mobile phones to report or obtain the ratings of one or more merchants. In some embodiments, the commerce engine may provide interfaces with some external entities (mobile phone operators, out side merchants) so that they can enquire and/or retrieve certain specific information from the merchant.

In some embodiments, the commerce engine provides some interfaces/functionalities so that the mobile phone becomes a distribution and sales channel for certain brick-and-mortar businesses and/or online businesses and/or other types of businesses.

In some embodiments, the commerce engine provides interfaces/functionalities to incorporate partnership and affiliate program information with other businesses. The mobile phone operator and/or other businesses may provide certain affiliate programs such that a user may store information that he/she is currently affiliated with an operator and/or business; this information may be sent with outgoing messages. This may offer several additional revenue channels for all the players.

In some embodiments, the commerce engine provides interfaces/functionalities to incorporate loyalty and/or reward programs.

In some embodiments, the commerce engine provides interfaces/functionalities for payment processing. The payment processing functionality may be interfacing with external vendors and/or with other mobile phone users and/or with mobile phone operators. In some embodiments, the merchant may limit accepting orders from clients of specific operators. In some embodiments, there may be certain types of pre-established payment processing arrangements between the merchant, buyer and the operator. The operator may charge a convenience fee for these types of arrangements and/or may provide certain incentives for buyer and/or merchant. This may provide additional revenue channels for the operator.

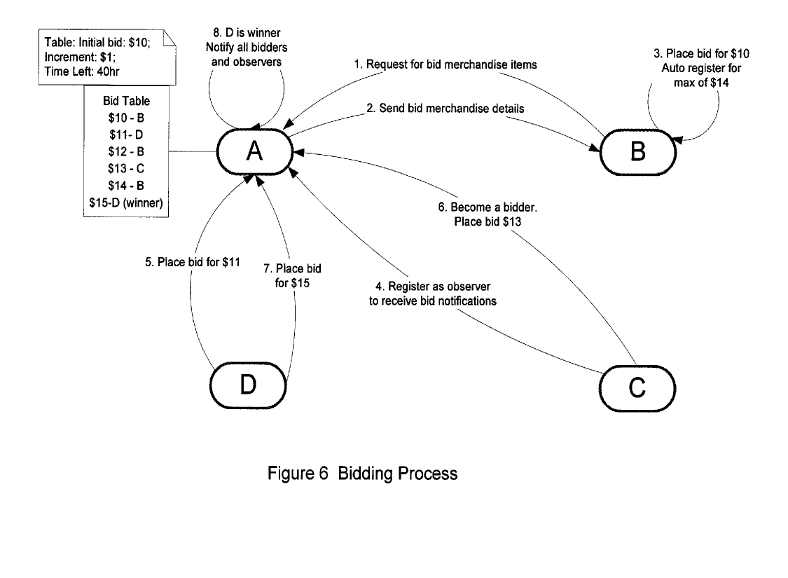

Turning now to FIG. 6, the method, system, and apparatus of the present invention also provides a distributed auction/bidding engine for mobile phones, and method to perform distributed auctioning without relying on a centralized server or physical network or wireless network. The purpose of distributed auction engine is to facilitate the process of bidding among mobile phones in a decentralized fashion. Traditional online auction sites work in centralized fashion, where a client connects to a server using a network connection and the server hosting the auction merchandise and auction/bidding software module implements the auctioning process. The client (or bidder) places a bid on the server and the server updates the information in one of its data stores. All bidding information is stored in a centralized place and users connect to the server to view bid merchandise, to place bids, to view bids and to perform other related tasks. Consequently, as discussed earlier, there are several issues associated in this connected environment for promoting habitual usage for mobile phone users. In our proposed method, auction engine using asynchronous store-and-forward messaging. This can be modified to use traditional synchronous messaging in a networked or connected environment. If it is implemented in a networked or connected environment, synchronous messaging will be used, but the auction data will be stored in a distributed fashion without relying on a centralized server. In the proposed method, bidding data and bidding merchandise data is not stored on a centralized server or on a network.

Referring back to FIG. 5.1, the bidding engine (distributed auction engine) is shown as an integral component of commerce engine. In some implementations, the bidding engine may be separated and configured to execute as a stand-alone application or as an application coupled with search engine. The user may use a GUI to interact with the bidding engine. Using a GUI the user may create and view and maintain the following: bidding merchandise information, bidding history information, bidder information, bidder history information, winner information, observer information, merchant information and other types of information. A bid merchant is the one who creates a store front of bidding merchandise on the mobile phone. Actual bidding process occurs on the mobile phone. A bidder is a user who places the bid on a bid item. Initially, a user identifies a bid item that he/she would like to bid by initiating a search request. The bid merchant sends the results to the requestor. Using a GUI, the user may select an item that interests him/her and places a bid. The bid is sent to the merchant, and the merchant notifies all other bidders and observers about the bid.

An observer is a user who is interested to observe the bidding process. The user registers with the merchant on a particular merchandise item and during the bidding process, the bidding updates are notified to the user. At any point in time, before the bidding process concludes, the observer can become a bidder and start placing the bids. At any point in time, the observer can notify the bid merchant to stop notifying with the bid updates.

Suppose if two bidders place a bid with the same bid price at the same time, then the bid merchant may use the time stamp (time received) to accept the bid price. In order to resolve contentions, the merchant may enforce certain policies to accept the bid prices. One such policy might be—always accept first received bid. In this case, the time stamp when the bid was received by the merchant will be used to determine the first received bid. Several such contention resolution procedures may be enforced by the merchant at any time. These policies may be displayed using a GUI and the merchant may configure to enforce them using the GUI or by other means.

The process of notifying notifications, process of placing bids, and process of updating bids occur using asynchronous store-and-forward messaging. In some embodiments, the bidder and/or observer may request the merchant to notify them using some other mechanism. That mechanism may be anything but not limited to sending emails, faxing, paging, alerting, sending sound signals and so on. A bidder places a bid using the GUI and the bid is sent to the merchant. If the bid satisfies all the necessary requirements the merchant may accept the bid, and may notify other bidders and observers. This notification about the change in the current bid price is called as ‘bid update’. Until the merchant accepts the bid, the bidder cannot place a new bid. After the merchant notifies about the bid update, the receiver may place another bid and the process continues until the merchant ends the bidding process and/or the bidding time reaches the time limit or expiration time. In some embodiments, the merchant may set the maximum bid price and who ever matches the maximum bid price will win the bid.

In some embodiments, the bidder may specify an initial bid price and a max bid price, and store this information on his/her mobile phone. Whenever a bid update is received, the bidding engine may automatically place the bids with the merchant in the said increments until the maximum bid price is reached. In this way, the bidder may not have to keep bidding every time a bid update notification is received. In some embodiments, the bidder may specify an initial bid price and a maximum bid price, and directly send this information to the merchant. The merchant may appropriately do the updates and the bidder may be notified by the merchant if he/she wins the bid, or when the maximum bid price is reached before the conclusion of the bidding process. In this way, the bidder may guard himself/herself from continuous bid updates from the merchant—a technique that may potentially reduce message traffic.

An example of the bidding process is shown in FIG. 6. Various extensions can be added to this method. In this embodiment, A represents a merchant who has created a bidding store front on the mobile phone. B and D are bidders, and C initially an observer becomes a bidder during the bidding process. Bidders are bidding on an item with an initial bid of $10, with bidding increment of $1 and the bidding process will be over in 40 hours. The arcs represent the actions and the number associated with the description of the arc represents the sequence of events. Certain detailed steps that may occur between the sequences of events are omitted for clarity reasons. As shown in FIG. 6: (1) B requests bid merchandise items from A; this may be by initiating a search request or by directly contacting the merchant. (2) ‘A’ (Merchant) sends the bid merchandise items to user B. (3) B goes thru the items, selects an item, and places the bid. B specifies the maximum bid price to $14 and auto-registers to automatically post the bids until it reaches $14. The merchant may maintain a table to keep track of bid updates and bidders. The merchant accepts the bid from B and updates the bid table with $10. (4) User C registers with the merchant (A) as an observer for this bid merchandise item. User C receives bid updates. (5) User D places a bid for $11. The merchant accepts the bid, updates the bid table and notifies other bidders and observers (B and C). Since B has auto-registered up to $14, the current bid will be immediately out bid by B for $12. The merchant accepts the bid, updates the bid table and notifies other bidders and observers (C and D). (6) C who was an observer until now becomes a bidder by placing a bid for $13. The merchant accepts the bid, updates the bid table and notifies other bidders and observers (B and D). Since B has auto-registered up to $14, the current bid will be immediately out bid by B for $14. The merchant accepts the bid, updates the bid table and notifies other bidders and observers (C and D). B is notified that his/her auto-registered maximum bid has been reached and no more bids can be automatically posted on behalf of B. (7) D places a bid for $15. The merchant accepts the bid, updates the bid table and notifies other bidders and observers (B and C). (8) Merchant doesn't receive any more bids; bidding stops when the time is reached; maximum bid is placed by D. Merchant notifies D as winner, and B and C are notified about the winner.

Once the bidding is completed the merchant and the winner may communicate to take the next necessary steps regarding payment and shipment. The bidding engine, if it is integrated with the commerce engine, may use the functionalities of the commerce engine for payment processing, for shipment or for other necessary functions. The bidding engine, if it is implemented as a separate stand-alone module, may implement certain functionalities of the commerce engine. These functionalities may be anything but not limited to reporting, logging, generating coupons for merchandise items, delivering coupons, obtaining customer registrations for future interested items, generating invoices, integrating with a server or some other device to perform synchronization tasks, communicating with an order processing system to fulfill orders, transferring merchandise and/or enquiries and/or order data to a server and/or to another computing device, and other functionalities. These functionalities may be implemented as additional modules and/or as standalone applications and these may be individually or totally integrated with the bidding engine.

The bidding engine may provide interfaces to an email system so that emails can be sent to the respective parties whenever an event occurs. The bidding engine may provide interfaces with printers, scanners, fax machines, and/or other output peripherals to output certain digital content. The bidding engine may provide interfaces so that instead of a user manually creating store fronts of bidding merchandise on their mobile phone, an external application may send message(s) and/or email to the bidding engine and message(s) may have enough information to create entire or partial store fronts of bidding merchandise on the mobile phone. The bidding engine may provide interfaces so that entire or partial store front data, order data, bidder information data and other bidding engine related information may be migrated to other mobile phone (s) or device(s) or server(s). The data migration may occur using any of the available methods but not limited to email, asynchronous and/or synchronous communication mechanisms, Infra Red, Bluetooth and other available methods to transfer data. The bidding engine running on the mobile phone may expose some interfaces or may expose certain interfaces or act like an intermediary for bidirectional or unidirectional data interaction between the mobile phone and an online shopping engine or online software module or a software component running on a network or a web service. The bidding engine might include certain exception handling and error processing functionalities to deal with uncertain behaviors, errors, unusual activities and abnormal program execution. The bidding engine may include certain security functionalities and/or may interact with a security application or module to enforce security policies. Security violations may be notified to the relevant parties using appropriate procedures. The merchant may block some users to search/view certain merchandise items and/or may restrict certain users from performing certain commerce related tasks.

Since all communications between mobile phones occurs using asynchronous store-and-forward messages, the messages may be encrypted using available technologies to protect privacy and user identity, and safeguard transaction secrecy. The bidding engine may be extended in functionality to perform certain group-auctioning transactions where multiple mobile phone users group together and place bids with a merchant. The mobile phone users will search the required merchandise and communicate with each other to group together to place a bid. The merchant mobile phone may receive bids from multiple users who have flocked together to enjoy group-buying advantages for the same item. In some embodiments, the merchant may create bidding merchandise items with tier-pricing information or bidding merchandise items that are exclusive for group buyers. In some embodiments the bidding engine may provide interfaces to integrate with some online auction sites, so that placing a bid on the online site may result in sending a message to the bid merchant mobile phone. In some embodiments the bidding engine may provide interfaces such that the bidder may send bids by a web page, email, page request using any type of device (computer, PDA, laptop, pager and other) to the bid merchant mobile phone. In some embodiments, the bidding engine may implement merchant rating functionality where a bid merchant is rated on several factors such as reliability, trust worthiness, shipping performance, payment handling, and customer service and other factors. The bidders and/or winners may fill in a scorecard and send to the merchant. The bidding engine computes the scorecard information received by several bidders and/or winners, and presents it in a form that is readable and perceivable by other users. It may be presented using any form such as star rating, numerical rating, and pictorial rating and other score card presentation forms. This rating information may be associated with all the bidding merchandise so that whenever a user requests for bidding merchandise information, the rating information may be sent with the requested information to the requestor. In some embodiments, a user may just send an exclusive message to the merchant to obtain the merchant rating information. In some embodiments, a user may send a query request within a group of mobile phones to obtain the ratings of one or more merchants. In some embodiments, the bidding engine may provide interfaces with some external entities (mobile phone operators, out side merchants and other), so that they may enquire and/or retrieve certain specific information from the merchant.

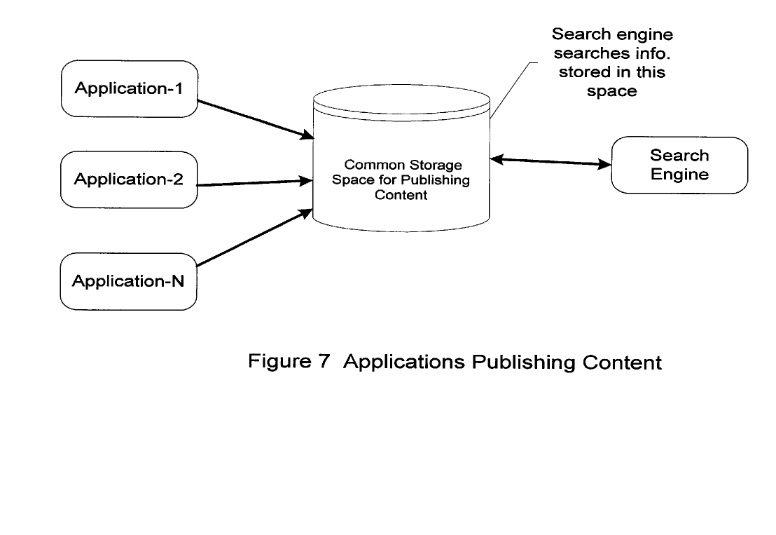

In another embodiment, as shown in FIG. 7, the method, system, and apparatus of the present invention provides for creation and/or publishing variety of digital content on the mobile phone and method to publish digital content created by other applications and make it available for discovery. The method allocates exclusive storage space on the mobile phone for publishing purposes, where users store/transfer information that they would like to publish in this area and the search engine will access this exclusive space for searching. This enables an application to publish its digital content without having to implement interfaces as prescribed by the search engine. The search engine may use its own logic to search data stored in this shared space.

Software applications on a mobile phone create new digital content or use existing digital content. For instance, as described earlier, users may create storefronts and publish merchandise items on their mobile phones using a GUI or by other means. Pictures, videos and/or multimedia content can be associated with merchandise items. Various details can be associated with the merchandise items: name, description, key words, title, price, quantity available, shipping information, and other details. Users can create auction fronts and publish auction items on their mobile phones using a GUI. Pictures, videos and/or multimedia content can be associated with bid merchandise items. In other instances, users can create albums (pictures, videos, music and other multimedia data) and publish them on their mobile phones using a GUI. In some other instances, users can create opinions on any item or subject or entity, and publish them on their mobile phones using a GUI. Pictures, videos and/or multimedia content may be associated with the opinions. In some embodiments, users may create classifieds (classified advertisements) and publish them on their mobile phones Pictures, videos and/or multimedia content can be associated with classified items. In some instances, users may create coupons and publish them on their mobile phones Pictures, videos and/or multimedia content may be associated with the coupons items. Using a GUI or by other means, users may be able to maintain (create, read, update, delete, publish, unpublish) the digital content on their mobile phones. In some instances, users can create their profile (any information that describes the users' interests, attributes, personality, behavior, qualities, character, traits, hobbies, leisure pursuits, actions, specialty, field of interest, subject matter expertise and so on) and this profile information is stored on the mobile phone. As shown in FIG. 7, digital content created by applications may be stored in an exclusive data store and the search engine will search this exclusive data store. In some instances, there can be several such isolated data stores and the search engine may search all available data stores.

Furthermore, users can publish content created by other applications. For example, contacts information created by Address Book application may be used for contacts search and/or endorsement search. Similarly, documents created by software applications such as Microsoft Office, Adobe Acrobat and other information publishing applications, may be published and made available to be discovered by other users.

In some instances, instead of using different applications or GUI to publish digital content, sometimes the user may prefer some short cuts to publish digital content. As shown in FIG. 7, the user may allocate some storage space on his/her mobile phone and reserve this space exclusively for storing published data. The user simply copies or transfers any digital content to this space. By default, any data that is stored in this space will be searched by the search engine. Certain maintenance functionalities (add, delete, update, publish/unpublish and so on) may be provided using a GUI or by other means so that the user may maintain digital content stored in this area. In one embodiment, an additional GUI menu option may be provided to all the applications running on the mobile phone, so that when the user selects this menu option from the application, the content will be automatically copied or transferred to this shared space. This mechanism offers the convenience to publish content without exiting the current application. In some instances, when multiple applications are storing content in this shared space, synchronization techniques may be provided to maintain data integrity. In another embodiment, a GUI menu option may be provided so that whenever a user clicks on any content stored on the mobile phone, a pop-up menu or the like may be displayed with options to copy or move the content to this exclusive storage space. In another embodiment, a GUI menu option may be provided so that when a user clicks on any content stored on the mobile phone, a pop-up menu will be displayed with a list of groups. The user simply selects one or more groups and the content may be made available to be searched by those selected groups only. Similarly, the pop-up menu may display name and/or numbers of certain people and/or entities and/or organizations, and the user selects one or more of the options and the content may be made available to be exclusively discovered by the selected people/entities/organizations. The user may associate key words with any digital content and the search engine would search for key words. The user may publish or unpublish a digital content at any time. The user may view published and unpublished content in different formats such as list view, tree view, icon view, tile view, details view, thumbnail view and other.

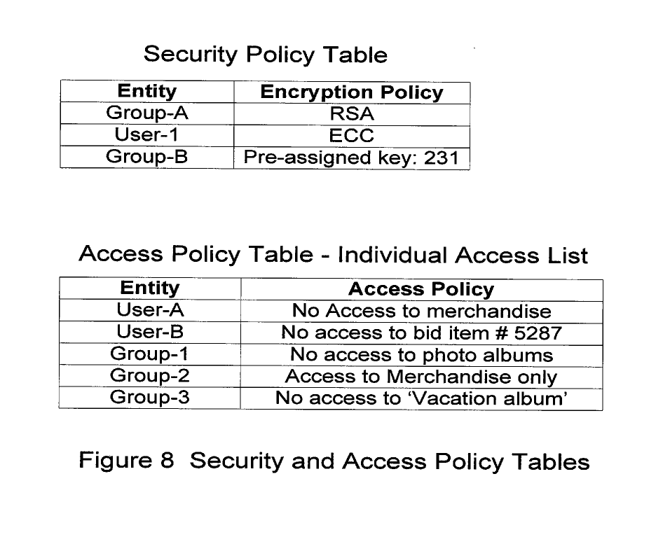

Turning now to FIG. 8, the method, system, and apparatus of the present invention provides for setting access and security policies to published digital content on the mobile phones. Mobile phone is a very personal device; information stored on the mobile phones is very personal to the users and they prefer to share information with people of their choice. However, the concept of groups, as explained earlier, provides a mechanism to share information with a crowd whom they are affiliated in one or more ways. Within the group, quite often, users may prefer to restrict access to certain group members and/or individuals to specific digital content. Besides, while sharing specific information, users are concerned about information security and prefer to protect their privacy. Users may prefer to share certain types of data in a secured manner. The proposed method provides a mechanism to enforce access policies and security policies on the digital content stored on the mobile phones. Access policies dictate whether a user has permissions to access specific information or not. Security policies dictate the type of data security that should be applied when sharing data with a person or group members. For example, while sharing data among a group of members, the security policy may be to encrypt data using a digital certificate, where as access policy may be to grant permission to access all photos except ‘vacation’ photos. The same user may use some standard encryption techniques (RSA or ECC or similar) with some other groups or group members. In some embodiments, the security policy may dictate to use digital signature(s) in all outgoing messages. Security policies also dictate certain authentication mechanisms such that no unauthorized user impersonates as a group member to access/share digital content. In one embodiment, a group might enforce a policy that all their members may use a pre-assigned security key in all outgoing messages. A user may maintain a ‘Security Policy’ table as shown in FIG. 8 on his/her mobile phone, so that communication with ‘Group-A’ is encrypted using ‘RSA’ technology, communication with a specific user ‘User-1’ is encrypted using ‘ECC’ technology, and communication with ‘Group-B’ is encrypted using a pre-assigned key ‘231’. In order to improve security, a different key may be assigned by a group administrator at fixed intervals (daily/weekly/quarterly/monthly). In some embodiments, the security key may be associated with expiration time stamp or expiration duration. The receiver, on receiving a request which contains a pre-assigned security key, may process the request if the pre-assigned key matches the key assigned by that particular group. The security policy may also include data store security: the security mechanism that should be applied to the data stored on individual mobile phones to protect from unauthorized access, and to maintain data integrity. Security policy information may be stored on the mobile phone and a user may enforce the policies using a GUI or by other means. A dedicated module—for instance, say Security Manager module—may retrieves the access policies and security policies, interprets them and enforces them as and when required. When a mobile phone receives a search request, the search engine or security module may use the access policies to decide whether a particular search request has the necessary permissions to search information or access data or perform the required operation. All security and access violations may be handled in a manner that is appropriate to the needs of the user and/or group. The violations may be logged, and an alert message may be sent to an authority and/or notify law enforcement officials, in a manner that is applicable and appropriate at the time of need. Access policies may be granted at per user level and/or at group level. A user may block certain users and/or certain groups from discovering and retrieving all or specific published digital content from his/her phone. Unpublished digital content may never be allowed to be discovered. Access policies are enforced on published data only.

Furthermore, when it comes to access policies, a user may maintain any number of access lists but not limited to the following: (1) Block List—information about people and/or groups who should never be allowed to search. When the search engine receives a request and if the sender is a member of this list, the request may not be processed. (2) Exclusion List—information about people and/or groups who should be excluded when initiating search requests or outgoing messages. When the user sends a search request, the search engine may propagate the requests to all the members of a group except the one listed in the exclusion list. In one embodiment, this information may be stored in a table and when a user sends a request, the request may not be sent to the groups and numbers listed in this table. (3) Individual Access List—information about specific people or groups, and their permissions to access specific information. In one embodiment, as shown in the FIG. 8, this information may be maintained as ‘Access Policy’ table on a mobile phone. As shown in ‘Access Policy’ table in FIG. 8, User-A cannot access merchandise content; User-B cannot access a particular bid item; Group-1 members cannot access photo albums; Group-2 members limited to access merchandise items only; Group-3 members have no access to a particular album, but can access everything else.

The user may maintain the access lists using the GUI or by other means, and the access list information may be stored on the mobile phone. Sometimes, the access policy and access policy data may be sent to a user by an operator and/or a provider and/or a group member and/or an external business entity or organization. In some embodiments, the user may include a spam policy where unsolicited messages, for example, group join request messages, may not be processed at all. In this way, the user can protect his/her mobile phone from being bombarded with unsolicited messages. In some embodiments, the user may maintain an ‘allowed list’ where messages sent by members of this list may be processed and messages sent by others who are not in this list may be automatically discarded. In some embodiments, the mobile phone may act like a firewall or as a router for the entire group, so that whenever a group member sends a request message, the message may be automatically sent to this firewall mobile phone, and it may direct the message to other mobile phones in the group. The firewall mobile phone may apply any policies—security policy, access policy, or other types of policies—that may be defined by the group; as a result, this may eliminate the need for all the mobile phone within the group to individually store and maintain group policies (access and/or security) and policy data. There may be other software applications and/modules which decipher the access and security policy information, and enforce them during certain events. Other mobile phone software components and/or applications may interact with the security and/or access software modules to perform specific security and access tasks. The security and access software modules may provide interfaces/functionalities to generate reports, and perform other auditing and/or administrative functionalities.

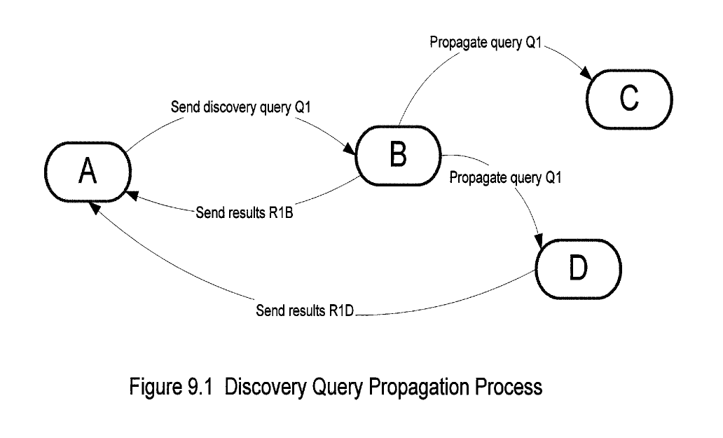

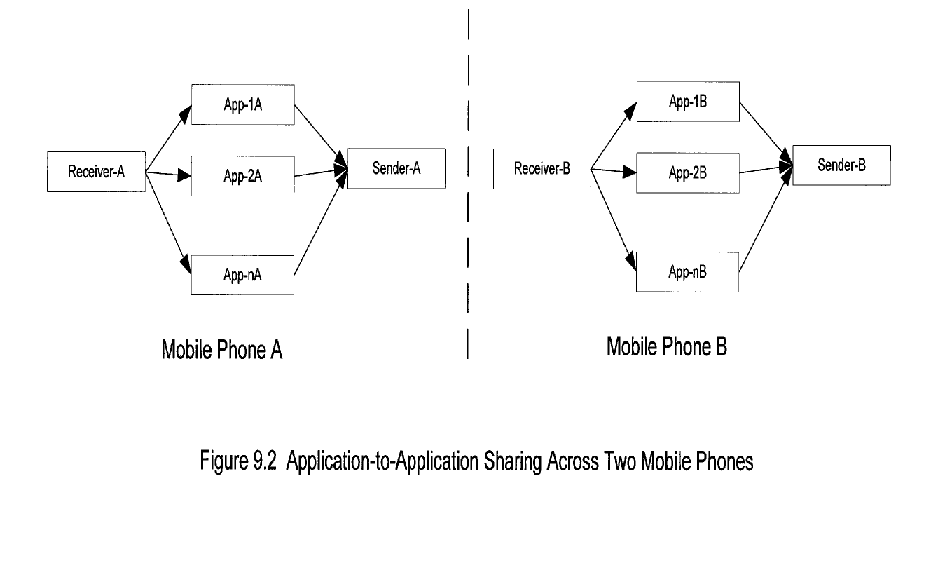

Turning now to FIG. 9.1, the method, system, and apparatus of the present invention provides for using asynchronous store-and-forward messages for remote discovery of digital content and for any other application specific purposes. As described earlier, asynchronous store-and-forward messages provide a mechanism to communicate with the devices that are not connected by any type of network. Even though if they are connected in a networked environment, it provides a reliable mechanism for message delivery. If the message recipient is not available, the message will not be lost and it will be delivered at a later time when the recipient is available. As described earlier, asynchronous store-and-forward messages not only can be used for discovering information on remote devices, but also can be used to perform application specific tasks between remote devices. In one embodiment, there will be a software application on a mobile phone and using the GUI the user may compose a discovery query. This query may be received by an application on the remote device and the query message may contain the necessary information to perform the task of discovery. If the results are found, then the application may compile the results, and send the results to the requestor. In some embodiments, the receiver may propagate the request to other receivers and if they find the results, the results may be directly sent to the requestor. In some embodiments the message may be configured such that the software application that receives the query may propagate the query to other devices on behalf of the original requester. Unlike previously mentioned embodiments where the application and search engine are two different entities, in this embodiment, some or all of the search engine functionalities may be embedded within the application, so that the application can discover information on other mobile phones without relying on the search engine. In this scenario, as mentioned earlier, not only the application can discover information on remote devices but also can direct remote applications to perform certain application specific tasks.

As shown in FIG. 9.1, the sender-A compiles a query message Q1 and sends to receiver-B. In some embodiments, sender-A might send the query to more than one receiver. Receiver-B, since it finds the matching result(s) for query Q1, will send the result(s) ‘R1B’ to sender-A, and will propagate the query Q1 to receiver-C and receiver-D. Now, receiver-D, since it finds the matching result, sends result(s) ‘R1D’ to sender-A, where as receiver-C will not send any results to sender-A. Each message contains enough information to remotely perform the search operation or specific application related operation, and return appropriate results to the requestor. The message content can be a combination of text and/or non-text. Message content can include a variety of information such as search query, application data, security information, devices to avoid, information about users and other information. In one embodiment, an application on one device communicates with the same application executing on the remote device. For instance, a camera application on one phone may communicate with a camera application on other phone using asynchronous store-and-forward messaging. In some embodiments, the message can be directed towards a specific application. For example, a camera application on one mobile phone may communicate with an ‘Address Book’ application (a application that stores contacts information) on other mobile phone. FIG. 9.2 illustrates an embodiment where different applications use a common sender and receiver modules to communicate with other devices. As shown in the FIG. 9.2, mobile phone A has receiver module receiver-A to receive messages and sender module sender-A to send outgoing messages. Similarly, mobile phone B has sender module sender-B and receiver module as receiver-B. On both these phones, applications 1 thru N (App-1A, App2A, . . . AppnA on mobile phone A, and App-1B, App-2B, . . . AppnB on mobile phone B) are integrated with the sender and receiver modules to send and receive messages respectively. These types of messages can be used to perform certain application specific tasks or directed to specific application that is currently installed on the mobile phones. Special code or logic may be incorporated in the message content so that the receiver may decipher the message content and direct the message to the intended application. As shown in the FIG. 9.2, application app-1A on mobile phone A will compose a message and uses sender-A to send the message to app-1B on mobile phone-B. Receiver-B on mobile phone B receives this message and delivers the message to app-1B. However, app-1A can send the message to any application on mobile phone B. In one embodiment, each application may use implements its own message handling infrastructure. In some embodiments, each application, instead of implementing their own message handling infrastructure to send and receive messages, can use the search engine infrastructure and its components for discovery and other communication purposes. In this scenario, the search engine messaging infrastructure will be used as a conduit to transfer messages across mobile phone applications. The application may be required to implement some interfaces as prescribed by the search engine, and when a message arrives, the search engine may execute the appropriate interface or place the message in a separate data store or execute some code or place the message in a separate application specific message queue. By re-using some of the infrastructure implemented by the search engine or by other applications, since a mobile phone has limited resources (memory and computing power and battery power), resources can be best utilized when executing multiple applications.

In another example, a user might have multiple mobile phones with camcorder application installed on individual mobile phones. The user uses this camcorder application to take videos and pictures on the mobile phone. In this embodiment, from the camcorder application of one mobile phone the user will send a message to discover a specific video or a picture that may be stored in other mobile phones. In another embodiment, the user may send the message to just one device and the device may propagate the message to other devices and those devices to other devices such that all devices will receive the message.

In another embodiment, the user may send a message with an actual file or specific digital content so that the file or the digital content is replicated on all the devices. In this way, data can be synchronized across all devices. In another embodiment, the application may send a message to some other application to search for information created by same and/or other applications on different mobile phones. They can send certain application specific messages to perform certain tasks such as data backups, alerting a user, request to send particular information and other tasks.

The method, system, and apparatus of the present invention provides for a mobile phone operator (or any provider of digital information) to send coupons and/or advertisements and/or any type of content that is specific to the user of a mobile phone based on the user profile and/or any other information. This information is stored such that other mobile phone users may be able to dynamically discover this information on demand. Besides, the method includes hosting advertisements and/or coupons and/or digital content on a mobile phone and inserting them when sending messages to other mobile phones. A user may create/store his/her profile (any information that describes the users' interests, attributes, personality, behavior, qualities, character, traits, hobbies, leisure pursuits, actions, specialty, field of interest, subject matter expertise and so on) using a GUI or by other means, and this profile information is stored on the mobile phone. The user may publish this information for other users, and/or providers and/or mobile phone operators on a timely basis and/or fixed time and/or one time only and/or at any time. In some instances, the user may retrieve the profiles of other users belonging to a group by sending messages. Sometimes the user may send a query to discover users with a particular profile within group(s). Sometimes the operator or other interested parties may retrieve this profile information from a mobile phone, and in return, they may send information that is specific to the user. Information sent by these providers can be anything but not limited to coupons, advertisements, tickets, vouchers, commercial ads, classified ads and any other promotional or marketing digital content that may match the users' profile. This information may be stored on the mobile phones and may be used by the user as and when required. In some instances, after a user receives this mentioned information from the provider, the user may configure this information to be searchable by other mobile phone users. Other users may initiate a search request to search other mobile phones for information sent by a provider.

In some embodiments, when a requestor sends a query message or any application specific message, the message might include an indicator to indicate that the sender of this message may be willing to receive coupons and/or advertisements and/or any other digital data other than the result. In that case, the receiver may send the appropriate coupons/advertisements in the response message for the sender. In some embodiments, a mobile phone might be exclusively hosting coupons and advertisements, and this might provide additional revenue channels to the user. In some instances, the mobile phone may insert the coupons and/or advertisements and/or any promotional related digital information in all outgoing messages. In some embodiments, there may be software modules on the mobile phones which track promotional information that may be sent in all outgoing messages, and generate reports. This reporting information may be sent to the providers and/or interested parties and the recipients of this information may use this for a variety of purposes such as determining revenue, determining usage, identifying and analyzing coupon/advertisement dispatching patterns, and so on. In one embodiment, the receiver of a message may have a policy to automatically filter out all promotional information that is embedded in the messages. The user may maintain this promotional information using a GUI or by other means.

The method, system, and apparatus of the present invention also provides a method for propagating a query (voice/video and/or other multimedia digital content) among mobile phone users to discover the right people who may assist them in solving their day-to-day problems—a method to find right people with the right knowledge and at the right time. Traditional online search techniques have enabled to find information that is stored on a computer and have not been successful in finding people accurately. The proposed method enables a user to find problem-solvers or trouble-shooters or subject matter experts, so that both the parties may be mutually benefited. A mobile phone is a personal device and the mobile phone reflects the personality of the user and it personifies the user in many aspects. Quite often we have encountered situations where we don't know whom to ask a question or who might have the subject matter expertise to give suggestions or answers for our questions. During these situations, we know that there are people within our groups or associations who may have the subject matter expertise, but due to lack of adequate information we cannot establish contact with them. Currently there are discussion groups and online applications (for example, Yahoo! Answers), where an online user poses a question and other online users answer the question. The current techniques work in a connected network environment, and it often fails to find the right, reliable, trustable, dependable, and executable answer from a trust-worthy source. Our proposed method enables a user to enter a question in text form or record a question or take a picture or movie about a problem description, associate this digital information with appropriate search criteria, and send this search request to find the right people within the group who may answer the question or find solution to the problem description. The requestor may create a query with a combination of text and/or multimedia content, and initiates a search in one or more groups. Using a GUI, or by other means, users may store information about themselves, their subject matter expertise, and their willingness to solve problems in certain subject matters and/or express their willingness to act as trouble shooters for certain subject matter specific problems.

When a mobile phone receives a query to find people, it matches with the stored information and if there is a match, the person is alerted to look into the problem. The person can view/listen/watch the multimedia query and may contact the requester with the appropriate response. However, the search engine may propagate this query to other users in the group. This method provides a mechanism for a user to advertise themselves about their services and subject matter expertise, and thereby offers an additional marketing and/or sales channel for their business and services.

The method, system, and apparatus of the present invention provides method to transfer meta data about published information or key words to an online search site (Google, Yahoo, MSN and so on) and/or to any online site, and when online users initiate a search, a list of mobile phone numbers and/or mobile phone user information that have the relevant information will be displayed on the web page. Online users will then directly contact the mobile phone user for more information. The user transfers meta-data information about the digital content created on the mobile phone to an online site. The online sites would store this information and make this a part of their search database, so that it can be searched by online users. Currently, the online search sites use web crawlers or similar technologies to gather information from the Internet, index them and allow users to search on this indexed information. However, when the user clicks on a search result, the user, quite often, goes to the actual web site. In the proposed method, a software component/application on the mobile phone creates meta-data from the published digital content stored on the mobile phone, and sends meta-data information to an online site. This meta-data may be sent to the online site at regular intervals or at one fixed time. The online sites may use this meta-data in any form but not limited to storing in a separate database, making it a part of their existing indexed data, creating a separate index and so on. The meta-data may include any information but not limited to information about the content, key words, a sub-set of content and/or provider information. In one embodiment, the online sites may provide a GUI control—‘Search Mobile Phones’ check box—on their web pages, and the user uses this GUI control to search mobile phones exclusively or inclusively. By default, this option may be always selected. Even though if this option is not provided, the online search software may be configured to search meta-data sent by mobile phones.

When an online user initiates a search on a web site, in addition to online search results, information from this meta-data information may be searched and matching results are displayed on the web site. Mobile phone user information may be displayed and online users may contact the mobile phone user for more information. Hence, this method allows a mobile phone user to be discovered by online and/or by users connected to a network, without transferring the stored digital content on his/her mobile phone in its entirety. In some embodiments, the mobile phone may register itself with certain online sites to receive search requests. The online sites will compose a search request and send an asynchronous message to the mobile phone and the mobile phone may send the results asynchronously to the user via email or by any other means to a location specified by the requester. Besides, this mechanism allows an online user to search one or more mobile phones directly from a web site. For instance, users with online email accounts may use this feature to search mobile phones.

The invention could further include a software module to identify usage of all these services and report to the operator and/or any provider, for a variety of purposes such as billing, data gathering, surveying, analyzing, profiling and other.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

It should be understood that the examples and embodiments described herein are for illustrative purposes only and that various modifications or changes in light thereof will be suggested to persons skilled in the art and are to be included within the spirit and purview of this application. The present invention has been described with reference to preferred embodiments.

1. A communication system for controlling transmission and reception of communications between a plurality of telecommunication devices in a group to allow searching of resources stored on the plurality of telecommunication devices, comprising
group management module for creating and maintaining association links for each of the plurality of telecommunication devices, wherein the association links of all the telecommunication devices in the group represent a logical network of telecommunication devices;
search engine for transmission and reception of communications between a plurality of telecommunication devices in a group, the search engine configured to route a search query from an originating telecommunication device along said association links to all telecommunication devices in the group, search stored resources in all telecommunication devices in the group, and return results of the search query to the originating telecommunication device, thereby allowing searching of stored resources on all the plurality of telecommunication devices without relying on a centralized server or physical network or wireless network for storing resources.

2. The communication system of claim 1 wherein the telecommunication devices are mobile devices.

3. The communication system of claim 1 wherein the telecommunication devices are mobile devices comprising one or more of cellular telephones, digital mobile phones, smart phones, web enabled phones, pagers, and PDAs.

4. The communication system of claim 1 wherein the communications are messages comprising one or more of text messages and multimedia messages.

5. The communication system of claim 4 wherein the text messages are communicated using asynchronous store-and forward messaging technology comprising Short Message Service (SMS) or Enhanced Messaging Service (EMS) or Multimedia Messaging Service (MMS).

6. The communication system of claim 4 wherein the multimedia messages are communicated using asynchronous store-and forward messaging technology comprising Multimedia Messaging Service (MMS).

7. The communication system of claim 1 wherein the group management module is configured to create association links between telecommunication devices by transmitting an invitation from a telecommunication device as invitor to one or more additional telecommunication devices as invitees and maintaining the association link between invitor and each invitee.

8. The communication system of claim 7 wherein the group management module is configured to identify the group with a unique group ID.

9. The communication system of claim 7 wherein the group management module is configured to perform one of the following actions upon receipt of an invitation: accept addition to group, decline addition to group, hold decision regarding group until a later time.

10. The communication system of claim 9 wherein the default action is accept addition to the group.

11. The communication system of claim 7 wherein maintaining the association link between invitor and each invitee comprises storing invitor identifying information on each invitee device and storing invitee identifying information on invitor device.

12. The communication system of claim 11 wherein the identifying information comprises information necessary to connect for transmission and reception of communications.

13. The communication system of claim 7 wherein the group management module is configured to assign one or more telecommunication devices with management functionalities comprising one or more of originating the group, administering the group, and controlling transmitting of invitations by all telecommunication devices in the group using a permissions-based mechanism.

14. The communication system of claim 13 wherein the association links between telecommunication devices form a tree of invitees such that one telecommunication device is the root and one or more invitees are organized into a pseudo-tree topology such that each invitee within the tree references its invitors as parents and its invitees as children.

15. The communication system of claim 14 wherein one or more paths for transmission and reception of communications are established throughout the tree of invitees.

16. The communication system of claim 15 wherein a secondary path for transmission and reception of communications is established between one or more telecommunication devices with management functionalities and each invitee.

17. The communication system of claim 16 wherein the secondary path is established by storing the identifying information of one or more telecommunication devices with management functionalities on each invitee device and storing invitee identifying information on the device of one or more telecommunication devices with management functionalities.

18. The communication system of claim 1 wherein the resources stored on the plurality of telecommunication devices comprise articles of commerce.

19. The communication system of claim 18 further comprising a transaction module configured to facilitate transmission and reception of communications for commerce transactions, thereby allowing searching of articles of commerce on all the plurality of telecommunication devices without relying on a centralized server or physical network or wireless network for storing resources, the transaction module further comprising a commerce engine for receiving and processing orders.

20. The communication system of claim 19, wherein the commerce engine comprises search functionality separate form the search engine.

21. The communication system of claim 18 further comprising a transaction module configured to facilitate transmission and reception of communications for commerce transactions, thereby allowing searching of articles of commerce on all the plurality of telecommunication devices without relying on a centralized server or physical network or wireless network for storing resources, the transaction module further comprising a bidding engine for auction related transactions.

22. The communication system of claim 21, wherein the bidding engine comprises search functionality separate from the search engine.

23. The communication system of claim 18 further comprising a transaction module configured to facilitate transmission and reception of communications for commerce transactions, thereby allowing searching of articles of commerce on all the plurality of telecommunication devices without relying on a centralized server or physical network or wireless network for storing resources.

24. The communication system of claim 23 wherein the transaction module provides for the purchase and sale of articles of commerce.

25. The communication system of claim 23 wherein the transaction module provides for the auction of articles of commerce.

26. The communication system of claim 1 wherein the resources stored on the plurality of telecommunication devices comprise digital content.

27. The communication system of claim 26 further comprising a social networking module configured to facilitate transmission and reception of communications for social networking, thereby allowing creating and searching of digital content on all the plurality of telecommunication devices without relying on a centralized server or physical network or wireless network for storing resources.

28. The communication system of claim 1 wherein the search query includes identifying information to allow the results of the search query to be sent directly to the originating telecommunication device.

29. The communication system of claim 1 wherein each telecommunication device comprises a user-defined access policy for authorizing access to all or part of the resources stored on the telecommunication device by other telecommunication devices in the group.

30. The communication system of claim 1 further comprising a group-wide access policy for authorizing access to all or part of the resources stored on all telecommunication devices in the group.

31. The communication system of claim 1 wherein each telecommunication device comprises a user-defined security policy for establishing security parameters needed to access the telecommunication device by other telecommunication devices in the group.

32. The communication system of claim 1 further comprising a group-wide security policy for establishing security parameters needed to access all telecommunication devices in the group.

33. The communication system of claim 1 wherein the resources comprise data representing one or more of merchandise, auction items, opinions, classifieds, photos, photo albums, sound files, multimedia data, videos, user profiles, coupons, advertisements, promotional data, documents, numerical data, image data, textual data, contacts and address book data, personal information management (PIM) data, and scientific data.

34. The communication system of claim 1 wherein transmission and reception of communications comprises asynchronous store-and forward messaging technology.

35. The communication system of claim 34 wherein the asynchronous store-and forward messaging technology stores communications including search queries and results in the event a telecommunication device is temporarily not operational to receive communications for subsequent delivery.

36. The communication system of claim 1 wherein the search engine is configured to allow exclusion of telecommunication devices to be searched.

37. The communication system of claim 1 wherein the search engine is configured to include a time limit for the search to be completed.

38. The communication system of claim 1 wherein the search engine is configured to allow selection of a list of groups to be searched.

39. The communication system of claim 1 wherein the search query includes information identifying the group.

40. The communication system of claim 1 wherein the search query includes information identifying the originating telecommunication device.

41. The communication system of claim 1 wherein the resources include user profile information to identify a user's interests for targeted marketing to a target user.

42. The communication system of claim 41 wherein the target marketing includes transmission of target marketing content including one or more of coupons, advertisements, tickets, vouchers, commercial advertisements, classified advertisements to the telecommunication device of the targeted user.

43. The communication system of claim 42 wherein the target marketing content is stored on the telecommunication device of the target user as a resource available for searching by other telecommunication devices in the group.

44. The communication system of claim 1 wherein the search query includes information regarding a specific problem in a defined subject area so that the user of the originating telecommunication device can search for another user of a telecommunication device in the group who is willing to assist in solving the problem in the defined subject area.

45. The communication system of claim 1 further comprising one or more functions of logging, record keeping, and reporting for each telecommunication device.

46. The communication system of claim 1 further comprising a backup utility to a remote server in communication with one or more telecommunication devices.

47. The communication system of claim 1 further comprising a user interface for each telecommunication device to access group management and search engine functionality.

48. The communication system of claim 1 wherein the search engine is configured to route a search query to any group of which the originating telecommunication device is a member.

49. The communication system of claim 1 wherein the stored resources are maintained on storage space allocated on the telecommunication device for publishing purposes.

50. An electronic commerce system for controlling transmission and reception of communications for commerce transactions between a plurality of telecommunication devices in a group to provide for the purchase and sale of articles of commerce listed on the plurality of telecommunication devices, comprising
group management module for creating and maintaining association links for each of the plurality of telecommunication devices, wherein the association links of all the telecommunication devices in the group represent a logical network of telecommunication devices;
commerce engine for transmission and reception of communications between a plurality of telecommunication devices in a group, the commerce engine configured to route a search query for an article of commerce from an originating telecommunication device along said association links to all telecommunication devices in the group, search articles of commerce listed on the plurality of telecommunication devices, return results of the search query to the originating telecommunication device, transact a sale of the article of commerce, thereby allowing commerce transactions for articles of commerce listed on all the plurality of telecommunication devices without relying on a centralized server or physical network or wireless network.

51. The electronic commerce system of claim 50 wherein the group management module further comprises security and group access control functions.

52. An electronic auction system for controlling transmission and reception of communications for auction transactions between a plurality of telecommunication devices in a group to provide for auctioning of articles of commerce listed on the plurality of telecommunication devices, comprising
group management module for creating and maintaining association links for each of the plurality of telecommunication devices, wherein the association links of all the telecommunication devices in the group represent a logical network of telecommunication devices;
auction engine for transmission and reception of communications between a plurality of telecommunication devices in a group, the auction engine configured to route a search query for an article of commerce from an originating telecommunication device along said association links to all telecommunication devices in the group, search articles of commerce listed on the plurality of telecommunication devices, return results of the search query to the originating telecommunication device, transact an auction of the article of commerce, thereby allowing auction transactions for articles of commerce listed on all the plurality of telecommunication devices without relying on a centralized server or physical network or wireless network.

53. The electronic auction system of claim 52 wherein the auction engine transacts the auction of the article of commerce with functionality to create and view and maintain one or more of bidding merchandise information, bidding history, bidder information, bidder history, winner information, observer information, and merchant information.

54. The electronic auction system of claim 52 wherein the auction engine provides functionality for a bid merchant to create a bid store front with one or more articles of commerce on the bid merchant's telecommunication device available for auction such that bidding for said articles of commerce is transacted on the bid merchant's telecommunication device, wherein the bidding process on the bid merchant's telecommunication device comprises receiving one or more bids from one or more bidders, adjusting the price of the article of commerce to an updated bid price, notifying all other bidders and observers of the updated bid price, ending the bidding process based upon one or more predetermined conditions, and notifying bidders and observers of the winning bidder.

55. The electronic auction system of claim 53 further comprising one or more functionalities of time stamping bid notifications from a bidder, implementing contention resolution procedures, security functions, blocking functions, privacy functions, encryption functions, group bidding, merchant rating, reporting, logging, generating coupons for merchandise items, delivering coupons, obtaining customer registrations for future interested items, generating invoices, integrating with a server to perform synchronization tasks, communicating with an order processing system to fulfill orders, transferring merchandise, transferring inquiries, email interfacing, output peripheral interfacing, receiving store front templates and pre-loaded store fronts, migration of data to another telecommunication device, integration with online auction sites such that placing a bid on the online site will result in notification to the telecommunication device.

56. The electronic auction system of claim 54 wherein the auction engine further provides functionality to allow a bidder to automatically place the bids with the bid merchant in predetermined increments until reaching a predetermined maximum bid.

57. The electronic auction system of claim 52 further comprising a commerce engine for providing one or more functionalities of payment processing, confirmations, shipment processing.

58. A social networking system for controlling transmission and reception of communications between a plurality of telecommunication devices in a group to allow searching of resources stored on the plurality of telecommunication devices, comprising
group management module for creating and maintaining association links for each of the plurality of telecommunication devices, wherein the association links of all the telecommunication devices in the group represent a logical network of telecommunication devices;
search engine for transmission and reception of communications between a plurality of telecommunication devices in a group, the search engine configured to route a search query for resources from an originating telecommunication device along said association links to all telecommunication devices in the group, search resources on the plurality of telecommunication devices, and return results of the search query to the originating telecommunication device, thereby allowing social networking and searching of resources of all the plurality of telecommunication devices without relying on a centralized server or physical network or wireless network.

59. A method for controlling transmission and reception of communications between a plurality of telecommunication devices in a group to allow searching of resources stored on the plurality of telecommunication devices, comprising
creating and maintaining association links for each of the plurality of telecommunication devices, wherein the association links of all the telecommunication devices in the group represent a logical network of telecommunication devices;
controlling the transmission and reception of communications between a plurality of telecommunication devices in a group, comprising routing a search query from an originating telecommunication device along said association links to all telecommunication devices in the group, searching stored resources in all telecommunication devices in the group, and returning results of the search query to the originating telecommunication device, thereby allowing searching of stored resources on all the plurality of telecommunication devices without relying on a centralized server or physical network or wireless network for storing resources.

60. A computer program product comprising a computer storage medium having a computer program therein for controlling transmission and reception of communications between a plurality of telecommunication devices in a group to allow searching of resources stored on the plurality of telecommunication devices, said computer program performing the steps of:
creating and maintaining association links for each of the plurality of telecommunication devices, wherein the association links of all the telecommunication devices in the group represent a logical network of telecommunication devices;
controlling the transmission and reception of communications between a plurality of telecommunication devices in a group, comprising routing a search query from an originating telecommunication device along said association links to all telecommunication devices in the group, searching stored resources in all telecommunication devices in the group, and returning results of the search query to the originating telecommunication device, thereby allowing searching of stored resources on all the plurality of telecommunication devices without relying on a centralized server or physical network or wireless network for storing resources.

61. A method of directly searching content stored on a plurality of telecommunication devices in a pre-established group, comprising
for all telecommunication devices in the group, establishing at least one communication path sufficient to route communications between all devices in the group, wherein the pre-established group is configured by creating association links between telecommunication devices and the path follows the links; and
controlling transmission and reception of communications between all devices in the group so that a search query from an originating telecommunication device is routed to all telecommunication devices in the group and replies to said query are returned to the originating telecommunication device, thereby enabling searching of stored content on all telecommunication devices in the group without relying on a centralized server or physical network or wireless network.

62. A method for creating and maintaining a linked group of telecommunication devices to allow searching of resources stored on all of the telecommunication devices in the group, comprising:
establishing one or more telecommunication devices with management functionalities;
assigning a unique group ID to identify the group;
creating association links between telecommunication devices by transmitting an invitation from a telecommunication device as invitor to one or more additional telecommunication devices as invitees, wherein the first invitation is sent by one of the telecommunication devices with management functionalities; and
maintaining the association link between invitor and each invitee by storing invitor identifying information on each invitee device and storing invitee identifying information on invitor device, wherein the association links of all the telecommunication devices in the linked group represent a logical network of telecommunication devices such that one or more paths for transmission and reception of communications are established throughout the association links.

63. The method of claim 62 further comprising storing on an online searchable site definitional data that provides summary information about the resources stored on one or more of the telecommunication devices in the group to allow a user of the online searchable site to contact the group for full access to the resources.

64. A method of directly searching content stored on a plurality of telecommunication devices in a pre-established group, comprising
receiving a search query from an originating telecommunication device;
if the search query was not already processed, processing the search query by verifying authorization to search, and if authorized, searching content on the telecommunication device and replying if content on the telecommunications device matches the search query; and
if the search query was not already processed, propagating the search query to a subset of devices in the group through pre-established links between group members until the search query is propagated to all telecommunication devices in the group, thereby enabling searching of stored content on all telecommunication devices in the group without relying on a centralized server or physical network or wireless network.

65. A method of using asynchronous store-and-forward messages for transmitting application specific tasks to be implemented by one or more applications stored on a plurality of telecommunication devices in a pre-established group, comprising:
for all telecommunication devices in the group, establishing at least one communication path sufficient to route communications between all devices in the group, wherein the pre-established group is configured by creating association links between telecommunication devices and the path follows the links; and
controlling transmission and reception of communications between all devices in the group so that an application specific task sent from an originating telecommunication device is routed to all telecommunication devices in the group, the application specific task containing code necessary to implement application specific tasks directed to applications on the telecommunication devices in the group receiving the task, thereby enabling application specific tasks to be implemented on all telecommunication devices in the group without relying on a centralized server or physical network or wireless network.

66. The method of claim 65 wherein the application specific task comprises searching digital content within an application on one or more of the telecommunication devices in the group.

67. The method of claim 65 wherein the application specific task comprises one or more command codes to direct an application on the telecommunication devices in the group to perform a task, said task comprising one or more of synchronizing, data backup, alert notification, and searching.

68. A method of locating remote resource data available on one or more telecommunication devices through an online search site, comprising
composing meta data summarizing remote resource data;
associating meta data with one or more telecommunication devices in a group having the remote resource data stored thereon;
storing meta data on an online search site available for searching by visitors to the online search site; and
providing contact information for one or more telecommunication devices in a group having the remote resource data associated with the meta data to visitors of the online site, thereby allowing visitors to locate remote resource data available on one or more telecommunication devices without storing the remote resource data on the online search site.

69. A method of using a plurality of telecommunication devices in a pre-established group as a router to route asynchronous store-and-forward messages between members of the group, comprising:
for all telecommunication devices in the group, establishing at least one communication path sufficient to route communications between all devices in the group, wherein the pre-established group is configured by creating association links between telecommunication devices and the path follows the links; and
controlling transmission and reception of communications between all devices in the group so that messages from an originating telecommunication device are routed to all telecommunication devices in the group without relying on a centralized server or physical network or wireless network.

70. A method of using asynchronous store-and-forward messaging to create a virtual network of telecommunication devices in a group, comprising
for all telecommunication devices in the group, establishing at least one communication path sufficient to route asynchronous store-and-forward message communications between all devices in the group, wherein the pre-established group is configured by creating association links between telecommunication devices and the path follows the links; and
controlling transmission and reception of asynchronous store-and-forward message communications between all devices in the group so that message communications from an originating telecommunication device are routed to all telecommunication devices in the group without relying on a centralized server or physical network or wireless network, said message communications configured to provide one or more functionalities of searching, sending results, propagating queries, group management, and conducting commerce between all devices in the group.

71. A method for propagating a search query among telecommunication device users in a pre-established group to discover at least one user who may provide assistance in solving a problem, comprising:
for all telecommunication devices in the group, establishing at least one communication path sufficient to route communications between all devices in the group, wherein the pre-established group is configured by creating association links between telecommunication devices and the path follows the links; and
controlling transmission and reception of communications between all devices in the group so that a search query from an originating telecommunication device is routed to all telecommunication devices in the group and replies to said query are returned to the originating telecommunication device, thereby enabling searching of stored content on all telecommunication devices in the group to discover at least one user who may provide assistance in solving a problem without relying on a centralized server or physical network or wireless network.
